(19) United States
(12) Patent Application Publication
(10) Pub. No.: US 2025/0077988 A1
(43) Pub. Date: Mar. 6, 2025

(54) SALES ASSISTANCE METHOD, SALES ASSISTANCE PROGRAM, AND SALES ASSISTANCE SYSTEM

(71) Applicant: Hitachi, Ltd., Tokyo (JP)

(72) Inventors: Etsuko NOMOTO, Tokyo (JP); Noriyuki HAGA, Tokyo (JP); Narumi KIDA, Tokyo (JP); Tetsuro ADACHI, Tokyo (JP)

(21) Appl. No.: 18/816,043

(22) Filed: Aug. 27, 2024

(30) Foreign Application Priority Data
Sep. 4, 2023 (JP) 2023-143017

(51) Int. Cl. G06Q 10/06; G06Q 10/20

(52) U.S. Cl. CPC G06Q 10/06; G06Q 10/20

(57) ABSTRACT

sales assistance method includes a priority potential client determination step of determining a priority potential client of a sales activity to be performed at a certain timing and a display/output control step for a priority potential client list. The priority potential client determination step includes an estimated update timing determination step of determining an estimated update timing about updating of a product, an estimated proposal period determination step of determining whether or not the certain timing is included in an estimated proposal period which is a period suitable to propose updating of the product to a potential client, and a priority measure step of treating the potential client such that the potential client is likely to be determined as the priority potential client, in a case where the certain timing is included in the estimated proposal period.

### CROSS-REFERENCE TO RELATED APPLICATION

The present application claims priority from Japanese application JP2023-143017, filed on Sep. 4, 2023, the content of which is hereby incorporated by reference into this application.

### BACKGROUND OF THE INVENTION

### 1. Field of the Invention

The present disclosure relates to an assistance technology for realizing efficient sales activities.

### 2. Description of the Related Art

There has conventionally been considered a possibility of providing, by an information processing system or the like, a sales representative or the like with information that contributes to sales activities to thereby allow the sales representative or the like to perform efficient sales activities.

In a prior art disclosed by JP-2002-24523-A, a search is performed in a sales representative database on the basis of predetermined search conditions, and information about clients is displayed in a sorted order on the basis of the order of priority of the search conditions. The prior art disclosed in JP-2002-24523-A allows models, age, and service meters of machines currently owned by clients (owned machines) to be set, as the search conditions. The information about the clients displayed in the sorted order is used for formulating a sales schedule.

JP-2004-259055-A discloses a prior art in which, after a budget formulation timing of a client is calculated, a message that represents an instruction to perform sales activities and is directed to a sales representative who is to perform sales activities for the client is generated when the budget formulation timing has come. Sales activities here mean activities to be performed by the sales representative to prompt the client to pay the fee for software the client is currently using.

### SUMMARY OF THE INVENTION

Since human resources as sales representatives or the like are limited, it is demanded to enhance the rate of sales activities for potential clients leading to actual delivery or the like of products (the efficiency of sales activities). For enhancement of the efficiency of sales activities, it is convenient if information about for which potential clients sales activities should be performed with priority at which timings is presented to sales representatives or the like.

For example, in a case where a target which a sales representative or the like attempts to deliver as a result of sales activities is a product having been updated when a product (e.g., an industrial machine) owned by a potential client is updated (re-delivered) after being in operation for a long period of time (e.g., for years to dozens of years), there can be a case where expert knowledge about the product or work experience is required in order to estimate a timing of updating (re-delivery) of the product. In addition, there can also be a possibility that the timing of updating (re-delivery) of the product varies (fluctuates) depending on the environmental status of the product owned by the potential client or the maintenance status of the product. Further, in a case where the price of the product is so high that a potential client is required to formulate a budget, the efficiency of sales activities can be enhanced if a sales representative or the like performs sales activities of proposing updating of the product to the potential client at a timing in the schedule of the potential client when updating (re-delivery) of the product is likely to be considered.

The prior art disclosed in JP-2002-24523-A requires a sales representative or the like to set search conditions including models, age, and service meters of machines (owned machines) currently owned by a potential client. Setting of search conditions for enhancing the efficiency of sales activities requires, in some cases, expert knowledge about machines (owned machines) currently owned by a potential client or work experience. That is, there can be a case where it is difficult for a sales representative or the like without abundant expert knowledge or work experience to set appropriate search conditions. In addition, even for sales representatives or the like with abundant expert knowledge or work experience, it is not easy to adjust search conditions taking into consideration the environmental statuses of machines (owned machines) owned by potential clients, the maintenance statuses of the machines (owned machines), and timings (consideration timings) in the schedules of the potential clients when updating (re-delivery) of the products is likely to be considered. First of all, setting search conditions and performing a search itself can be complicated for sales representatives or the like.

The prior art disclosed in JP-2004-259055-A relates to fee payment of software used by a potential client. Accordingly, handling of a timing of updating (re-delivery) of a product that is updated (re-delivered) after being in operation for a long period of time (e.g., for years to dozens of years) and handling of a timing of fee payment of software in the prior art disclosed in JP-2004-259055-A are of different kinds. In addition, in the prior art disclosed in JP-2004-259055-A, a message that represents an instruction to perform sales activities and is directed to a sales representative who performs sales activities for a client is generated when a budget formulation timing has come. That is, each message in the prior art disclosed in JP-2004-259055-A is only an instruction for individual sales activities, and does not represent the order of priority in overall sales activities at a certain timing.

In view of what has been described above, one of objects of the present disclosure may be to present, to sales representatives or the like, information about for which potential clients sales activities should be performed with priority at which timings, in order to enhance the efficiency of sales activities.

In addition, for example, one of objects of the present disclosure may be to present, to sales representatives or the like, information about for which potential clients sales activities should be performed with priority at which timings, without requiring setting of search conditions by the sales representatives or the like, even if the targets of handling of sales activities are such products that it is appropriate by nature to determine timings for performing sales activities of proposing updating of the products by assessment taking into consideration at least any one of expert knowledge about the products, work experience, the environmental statuses of the products, the maintenance statuses of the products, and consideration timings of potential clients, the products including products that are to be updated (re-delivered) after being in operation for a long period of time (e.g., for years to dozens of years).

In order to achieve at least one of the objects described above, features that the present disclosure can include are as follows, for example.

One aspect of the present disclosure relates to a sales assistance method executed by a computer. A sales assistance method includes a priority potential client determination step of determining, from among potential clients, a priority potential client to be treated as a priority target of a sales activity to be performed at a certain timing, and a priority potential client list display/output control step of performing control to display or output a priority potential client list representing information about the priority potential client of the certain timing. The priority potential client determination step includes, as steps to be executed for each of the potential clients, an estimated update timing determination step of determining an estimated update timing which is an estimated timing when a product owned by a potential client is to be updated, an estimated proposal period determination step of determining whether or not the certain timing is included in an estimated proposal period which is a period suitable to propose updating of the product to the potential client in order to update the product at the estimated update timing, and a priority measure step of treating the potential client such that the potential client is likely to be determined as the priority potential client for the certain timing, in a case where the certain timing is included in the estimated proposal period of the potential client.

As described above, according to the present disclosure, control is performed such that priority potential clients at a “certain timing” when sales activities are to be performed are determined and a priority potential client list of the “certain timing” is displayed or output. Accordingly, the present disclosure makes it possible to present, to sales representatives or the like, information about for which potential clients sales activities should be performed with priority at which timings, in order to enhance the efficiency of sales activities.

In addition, as described above, according to the present disclosure, about each potential client, an estimated update timing which is an estimated timing when a product owned by a potential client is to be updated is determined, it is determined whether or not a “certain timing” when sales activities are to be performed is included in an estimated proposal period which is a period suitable to propose updating of the product to the potential client in order to perform updating of the product at the estimated update timing, and the potential client is treated such that the potential client is likely to be determined as a priority potential client for the “certain timing,” in a case where the “certain timing” is included in the estimated proposal period of the potential client. Accordingly, according to the present disclosure, for example, even if the targets of handling of sales activities are such products that it is appropriate by nature to determine timings for performing sales activities of proposing updating of the products by assessment taking into consideration at least any one of expert knowledge about the products, work experience, the environmental statuses of the products, the maintenance statuses of the products, and consideration timings of potential clients, including products that are to be updated (re-delivered) after being in operation for a long period of time (e.g., for years to dozens of years), it is possible to present, to sales representatives or the like, information about for which potential clients sales activities should be performed with priority at which timings, without requiring setting of search conditions by the sales representatives or the like.

A sales assistance program and a sales assistance system that realize matters similar to those of the sales assistance method described above can attain effects and advantages similar to those of the sales assistance method. If a mode of a program is adopted, expenses are reduced in many cases. In the case of the program, design changes about processes are easy to make.

Features that the present disclosure can have other than those described above and effects and advantages corresponding to the features are disclosed in this specification, claims, or figures.

### BRIEF DESCRIPTION OF THE DRAWINGS

FIG. 1 depicts a functional configuration and a system configuration of an embodiment of the present disclosure;

FIG. 2 depicts a computer architecture that realizes the embodiment of the present disclosure;

FIG. 3 depicts an internal configuration of a sales record database;

FIG. 4 depicts an internal configuration of a product information database;

FIG. 5 depicts an internal configuration of a corporation database;

FIG. 6 depicts an internal configuration of a determination database;

FIG. 7 depicts a flowchart of a main routine;

FIG. 8 depicts a flowchart of priority potential client determination;

FIG. 9 depicts a flowchart of a priority measure;

FIG. 10 depicts a summary of a post-delivery-time-attributed priority measure;

FIG. 11 depicts a flowchart of the post-delivery-time-attributed priority measure;

FIG. 12 depicts a flowchart of estimated update timing determination about an owned product;

FIG. 13 depicts a flowchart of estimated-update-time determination (temperature-attributed);

FIG. 14 depicts a flowchart of estimated-update-time determination (dust-volume-attributed);

FIG. 15 depicts a flowchart of determination about a post-delivery-time-attributed update proposal target;

FIG. 16 depicts a summary of a repair-cost-attributed priority measure;

FIG. 17 depicts a flowchart of the repair-cost-attributed priority measure;

FIG. 18 depicts a flowchart of determination about a repair-cost-attributed update proposal target;

FIG. 19 depicts a flowchart of a priority measure attributable to another factor;

FIG. 20 depicts a flowchart of estimated consideration period determination;

FIG. 21 depicts a flowchart of pre-correction score calculation (existing client);

FIG. 22 depicts a flowchart of pre-correction score calculation (new client);

FIG. 23 depicts an internal configuration of corporation item-by-item score information and pre-correction score information;

FIG. 24 depicts an internal configuration of individual item-by-item score information and pre-correction score information;

FIG. 25 depicts a flowchart of priority potential client list display/output control;

FIG. 26 depicts a priority potential client list summary page;

FIG. 27 depicts a first example of a priority potential client list details page;

FIG. 28 depicts a graph expressed by update timing distribution information; and

FIG. 29 depicts a second example of the priority potential client list details page.

### DESCRIPTION OF THE PREFERRED EMBODIMENT

Hereinbelow, an embodiment of the present disclosure is explained in detail with reference to the figures. Note that the embodiment explained below does not limit the disclosure according to claims, and all of elements explained in the embodiment and combinations thereof are not necessarily essential for means for solving of the present disclosure. The description and figures described below illustrate examples for explaining the present disclosure, and, for clarification of the explanation, there are omissions and simplifications as appropriate. The present disclosure can also be implemented in various other modes. Unless there is a particular limitation, there are no problems even if the number of each constituent element is one or greater than one. The position, size, shape, area, and the like of each constituent element depicted in the figures do not represent its actual position, size, shape, area, and the like in some cases in order to facilitate understanding of the invention. Because of this, the present disclosure is not necessarily limited to positions, sizes, shapes, areas, and the like disclosed in the figures.

Each of systems, apparatuses, and functional sections of the present disclosure may be integrated into one in terms of hardware, or may include a plurality of separate portions and play a role through coordination between the portions. Several systems, apparatuses, or functional sections may be integrated in terms of hardware.

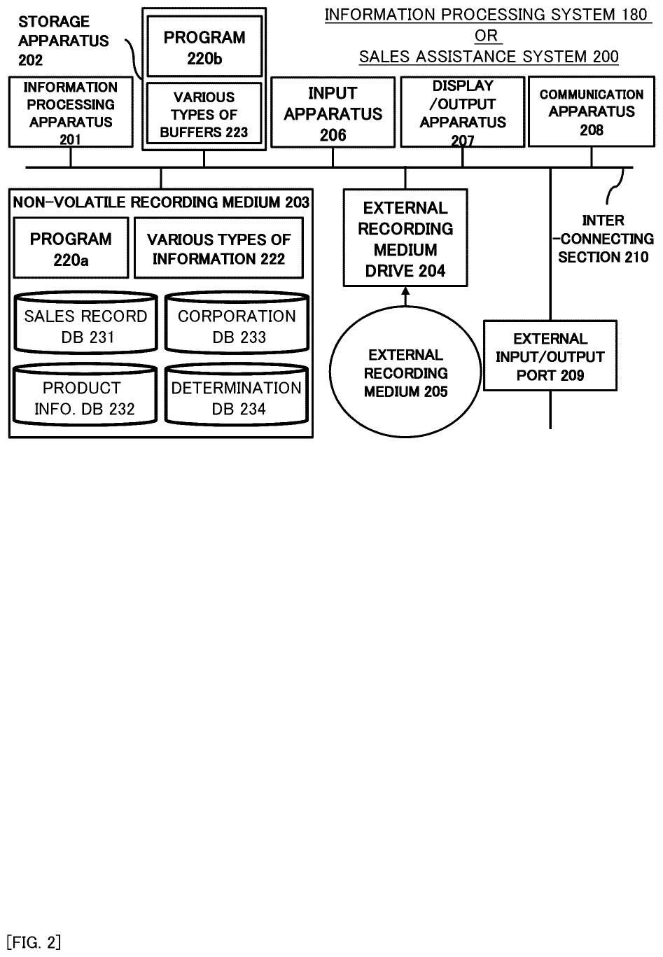

Each of systems, apparatuses, and functional sections may be realized by causing a computer to execute software (program) (as in FIG. 2). Some of functions of systems, apparatuses, or functional sections may be realized by hardware (e.g., a hardwired logic or a field-programmable gate array (FPGA)), and the remaining functions may be realized by execution of software (program). All of functions of each of systems, apparatuses, or functional sections may be realized hardware-wise. Some or all of steps of processes depicted in flowcharts and the like explained in the present disclosure may be realized in terms of hardware.

One or more of systems, apparatuses, and functional sections of the present disclosure may be realized by one or more hardware resources. Because of this, each of systems, apparatuses, and functional sections of the present disclosure may be realized virtually. For example, virtual computers or container approaches may be used.

A program of the present disclosure may be anything that is included in the concept incorporating ones in general that are equivalent to software by which an information processing system (sales assistance system) or an operation method therefor (sales assistance method) unique to purposes of use is built through collaboration between the software and hardware resources. That is, the program of the present disclosure is not limited to a particular type or mode of program. In addition, the program may be initially recorded in a compressed format.

Those for which the same reference numerals are used throughout a plurality of figures are similar to each other. In figures depicting flowcharts, oblong boxes represent steps of processes, and hexagonal boxes represent steps of conditional branches. In figures depicting flowcharts, “Steps” are abbreviated as “S.” In addition, in figures, databases are abbreviated as “DB.” Further, modes of display or output depicted in figures are examples, and are not the sole examples.

In the following explanation, “timings,” “periods,” and “time” have mutually different meanings.

“Timings” represent absolute positions in a time series with relatively short duration in sales activities. For example, “timings” may mean a particular one-day period such as Aug. 15, 2023 or a particular one-month period such as August 2023.

“Periods” represent absolute positions in a time series with relatively long duration (as compared to “timings”) in sales activities. For example, “periods” may mean a particular three-month period such as April to June 2024. Note that there may be cases where the duration of a certain “timing” and the duration of a certain “period” are almost the same.

“Time” may be one that is specified by the duration of time sandwiched between a particular time (or a “timing” or a “period”) and another time (or a “timing” or a “period”) and that does not represent an absolute position in a time series. “Time” may be expressed in any units such as years, months, days, hours, minutes, or seconds. For example, there is “time” with duration of 90 days between a “timing” which is 00:00:00 on Aug. 16, 2023, and another “timing” which is 00:00:00 on Nov. 14, 2023.

Whereas the words “corporation” and “individual” are used to refer to potential clients in the following explanation, they may have broad meanings.

“Corporations” may mean not only typical corporations but also organizations in general that perform organized activities. For example, “corporations” may be public institutions.

“Individuals” may mean not only individual humans but also relatively small-scale groups of humans (which are smaller than groups of overall constituent members of “corporations”). For example, “individuals” may be a group of a technical department or a group of a sales department belonging to a certain corporation.

Whereas the targets of transactions in sales activities are expressed as “products” in the following explanation, the “products” may have a broad meaning. Hereinbelow, for example, “products” are not only industrial machines, but also any goods that can be introduced (delivered) or updated (re-delivered).

### 1. Functional Configuration and System Configuration of Embodiment of Present Disclosure

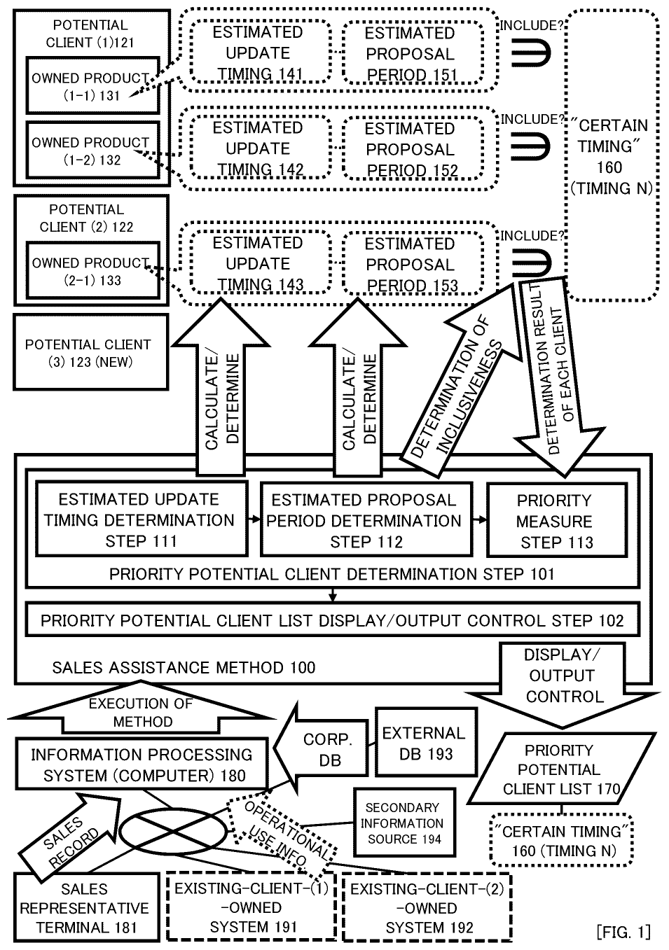

FIG. 1 depicts the functional configuration and the system configuration of the embodiment of the present disclosure. Note that it is not always the case that the entire functional configuration and system configuration depicted in FIG. 1 are essential. The functional configuration of the embodiment of the present disclosure is explained first, and the system configuration of the embodiment of the present disclosure is explained next.

First, in the embodiment of the present disclosure, a sales assistance method 100 (or a sales assistance program) may be executed by an information processing system 180 (or a computer). The sales assistance method 100 includes a priority potential client determination step 101 (to be executed earlier) and a priority potential client list display/output control step 102 (to be executed later).

The priority potential client determination step 101 determines, from among potential clients, priority potential clients to be treated as priority targets of sales activities to be performed at a certain timing 160. As examples of potential clients, FIG. 1 depicts a certain potential client (1) 121 which is an existing client, a certain potential client (2) 122 which is an existing client, and a certain potential client (3) 123 which is a new client. The number of potential clients (the number of existing clients and the number of new clients) are not limited to those depicted in FIG. 1. The priority potential client determination step 101 determines priority potential clients at the certain timing 160 from among the potential clients 121 to 123.

The priority potential client list display/output control step 102 performs control such that a priority potential client list 170 representing information about the priority potential clients of the certain timing 160 is displayed or output. By causing the priority potential client list 170 for the certain timing 160 to be displayed or output for, for example, a sales representative or the like, the sales representative or the like can obtain information for efficiently executing sales activities to be performed at the certain timing 160. Here, a mode of display or output of the priority potential client list 170 may be one in which a display/output apparatus 207 (depicted in FIG. 2) of the information processing system 180 displays or outputs the priority potential client list 170, or may be one in which information about the priority potential client list 170 is transferred to a sales representative terminal 181 which can mutually communicate with the information processing system 180 and a display/output apparatus of the sales representative terminal 181 displays or outputs the priority potential client list 170.

The priority potential client determination step 101 may include, as steps to be executed for each of the potential clients, an estimated update timing determination step 111, an estimated proposal period determination step 112, and a priority measure step 113. Regarding the example in FIG. 1, the estimated update timing determination step 111, the estimated proposal period determination step 112, and the priority measure step 113 are executed for at least each of the potential client (1) 121 and the potential client (2) 122 (which are the existing client).

The estimated update timing determination step 111 determines an estimated update timing which is an estimated timing of updating of a product owned by a potential client (re-delivery of the product). In the example in FIG. 1, the estimated update timing determination step 111 determines (calculates) an estimated update timing 141 and an estimated update timing 142 of an owned product (1-1) 131 and an owned product (1-2) 132, respectively, owned by the potential client (1) 121. In addition, in the example in FIG. 1, the estimated update timing determination step 111 determines (calculates) an estimated update timing 143 of an owned product (2-1) 133 owned by the potential client (2) 122. At the estimated update timing determination step 111, expert knowledge about the owned products 131 to 133, knowledge obtained by work experience, information about the environmental statuses of the products, or information about the maintenance statuses of the products may be used to determine (calculate) the estimated update timings 141 to 143 of the owned products 131 to 133.

The estimated proposal period determination step 112 determines whether or not the certain timing 160 is included in an estimated proposal period which is a period suitable to propose updating of a product to a potential client in order to update (complete re-delivery of) the product at the estimated update timing. In the example in FIG. 1, the estimated proposal period determination step 112 determines (calculates) an estimated proposal period 151, which is a period suitable (for a sales representative or the like) to propose updating (re-delivery) of the owned product (1-1) 131 to the potential client (1) 121 in order to update (complete re-delivery of) the owned product (1-1) 131 at the estimated update timing 141. Then, the estimated proposal period determination step 112 determines whether or not the certain timing 160 is included in the estimated proposal period 151. That is, it is determined whether or not the certain timing 160 is a timing suitable to propose updating (re-delivery) of the owned product (1-1) 131. In the example in FIG. 1, the estimated proposal period determination step 112 makes determinations similar to that described above also about each of the owned product (1-2) 132 and the owned product (2-1) 133, and determines whether or not the certain timing 160 is a timing suitable to propose updating (re-delivery) of each of the owned product (1-2) 132 and the owned product (2-1) 133. At this estimated proposal period determination step 112, expert knowledge about the owned products 131 to 133, knowledge obtained by work experience, or information about timings (consideration timings) when updating (re-delivery) of the products is likely to be considered in the schedules of the potential clients may be used to determine whether or not the certain timing 160 is a timing suitable to propose updating (re-delivery) of the products.

The priority measure step 113 treats a potential client such that the potential client is likely to be determined as a priority potential client for the certain timing 160, in a case where the certain timing 160 is included in the estimated proposal period of the potential client. In the example in FIG. 1, (since it can be said that it is suitable (for a sales representative or the like) to propose updating (re-delivery) of at least any one of the owned product (1-1) 131 and the owned product (1-2) 132 owned by the potential client (1) 121 to the potential client (1) 121 at the certain timing 160) if the certain timing 160 is included in the estimated proposal period 151 or the certain timing 160 is included in an estimated proposal period 152, the priority measure step 113 treats the potential client (1) 121 such that the potential client (1) 121 is likely to be determined as a priority potential client of the certain timing 160. Similarly, in the example in FIG. 1, (since it can be said that it is suitable (for a sales representative or the like) to propose updating (re-delivery) of the owned product (2-1) 133 owned by the potential client (2) 122 to the potential client (2) 122 at the certain timing 160) if the certain timing 160 is included in an estimated proposal period 153, the priority measure step 113 treats the potential client (2) 122 such that the potential client (2) 122 is likely to be determined as a priority potential client of the certain timing 160. Here, as an approach to treating a certain potential client such that the certain potential client is likely to be determined as a priority potential client of the certain timing 160, for example, as described later, an approach to increasing a coefficient by which a pre-correction score calculated for each potential client is multiplied may be used.

The functional configuration of the embodiment of the present disclosure has been explained above, and the system configuration of the embodiment of the present disclosure is explained below. An example of the system configuration is depicted in the lower portion of FIG. 1.

As has been depicted already, the sales assistance method 100 (or the sales assistance program) itself may be executed by the information processing system 180 (or the computer). The information processing system 180 that executes the sales assistance method 100 (or the sales assistance program) may be called a sales assistance system 200 (as in FIG. 2).

As depicted in the lower portion of FIG. 1, the information processing system 180 may be made capable of mutual communication with one or more of the sales representative terminal 181, an Existing-Client-(1)-owned system 191, an Existing-Client-(2)-owned system 192, an external database 193, and a secondary information source 194 through a network or the like.

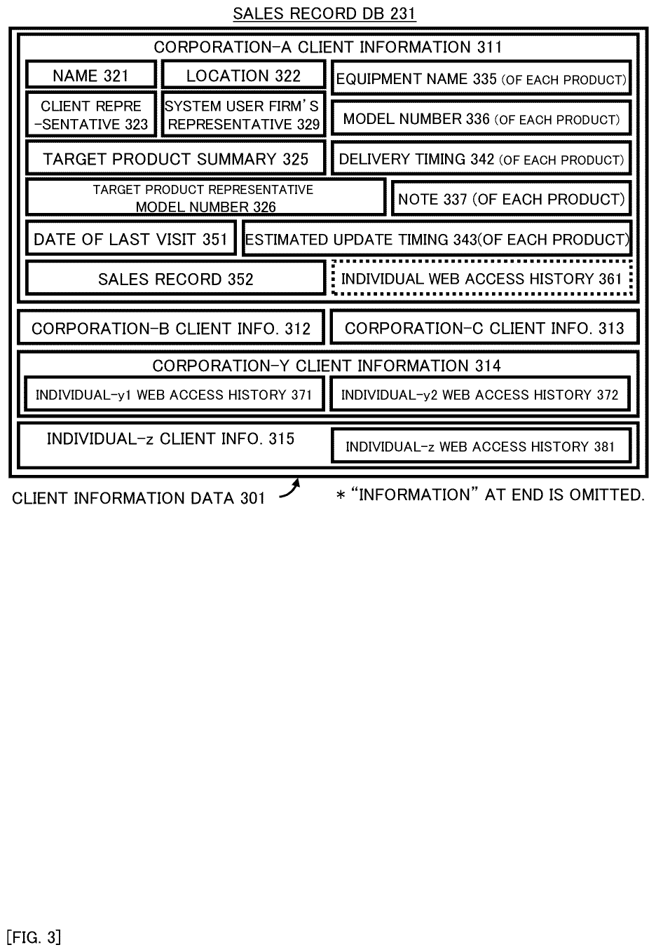

The sales representative terminal 181 is used by a sales representative or the like for sales activities. For example, the sales representative terminal 181 may be a portable device (a mobile information terminal (personal digital assistant (PDA)), a laptop personal computer, a smartphone, etc.). The sales representative or the like may input information about clients that has been obtained in sales activities to the sales representative terminal 181. Then, in real time or not in real time, the information about the clients may be transmitted from the sales representative terminal 181 and received by the information processing system 180. The information about the clients received by the information processing system 180 may be accumulated in a sales record database 231 (depicted in FIG. 2 and FIG. 3).

The sales representative terminal 181 may receive information about the priority potential client list 170 from the information processing system 180 (sales assistance system 200), and display or output the priority potential client list 170. In a case where the sales representative terminal 181 displays or outputs the priority potential client list 170, the convenience for the sales representative or the like can be enhanced.

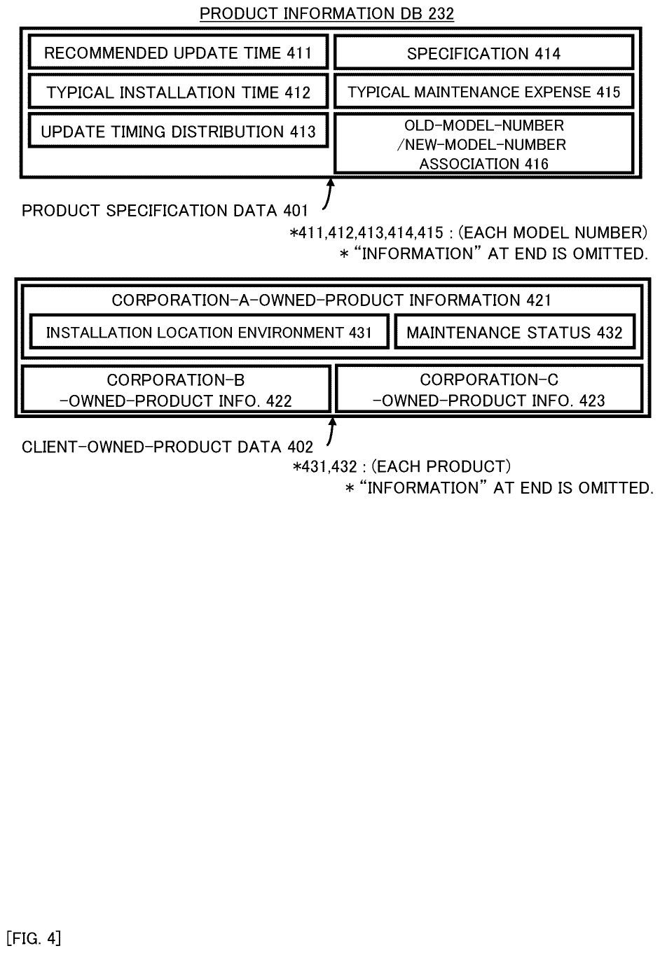

The Existing-Client-(1)-owned system 191 is a system owned by the potential client (1) 121 or a system operating for the potential client (1) 121. Information about the environmental statuses of products being operationally used such as the owned product (1-1) 131 or the owned product (1-2) 132 owned by the potential client (1) 121 or information about the maintenance statuses of the products being operationally used may be transmitted from the Existing-Client-(1)-owned system 191 and received by the information processing system 180. The information about the environmental statuses of the products being operationally used or the information about the maintenance statuses of the product being operationally used received by the information processing system 180 may be accumulated in a product information database 232 (depicted in FIG. 2 and FIG. 4). The role of the Existing-Client-(2)-owned system 192 is also similar to the role of the Existing-Client-(1)-owned system 191 (except that the target of the Existing-Client-(2)-owned system 192 is the potential client (2) 122). Note that the transmission from the Existing-Client-(1)-owned system 191 or the Existing-Client-(2)-owned system 192 and the reception by the information processing system 180 of the information about the environmental statuses of the products being operationally used or the information about the maintenance statuses of the products being operationally used are not essential. In a case where the information about the products being operationally used is not transmitted and received, the sales assistance method 100 (sales assistance program, sales assistance system 200) may use information obtained when each of the owned products 131 to 133 is delivered or information obtained by a sales representative or the like in her/his sales activities may be used to analogically infer information about the environmental statuses of the products or information about the maintenance statuses of the products.

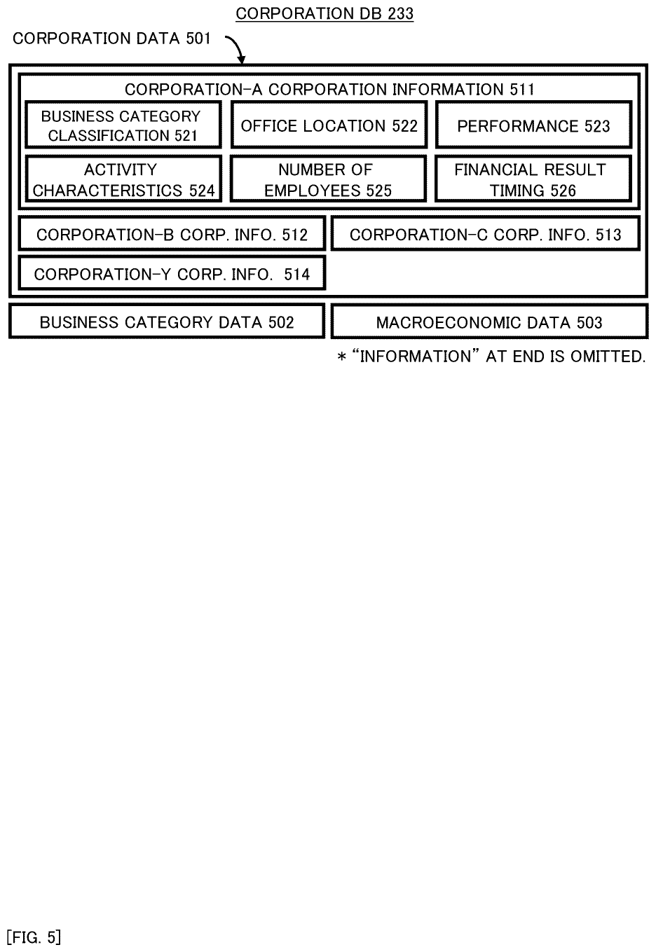

The external database 193 or the secondary information source 194 may give corporation data or the like to the information processing system 180. The corporation data or the like may be corporation data including corporation information about each corporation (e.g., including investor relations (IR) information which is information about each corporation for investors), business category data including business category information about each business category, or macroeconomic data including macroeconomic information about each country, each region, or the like. The corporation data or the like received by the information processing system 180 may be accumulated in a corporation database 233 (depicted in FIG. 2 and FIG. 5). Note that it is not essential to build the corporation database 233 inside the information processing system 180. Instead of building the corporation database 233 inside the information processing system 180, the information processing system 180 may obtain necessary corporation information, business category information, macroeconomic information, or the like from the external database 193 or the secondary information source 194 every time corporation data or the like is necessary.

The sales assistance method 100 (sales assistance program, sales assistance system 200) according to the present disclosure has the functional configuration described above. Accordingly, the sales assistance method 100 (sales assistance program, sales assistance system 200) according to the present disclosure can achieve advantages depicted in paragraphs and described before.

### 2. Computer Architecture for Realizing Embodiment of Present Disclosure

FIG. 2 depicts a computer architecture for realizing the embodiment of the present disclosure.

In order to realize the information processing system 180 or the sales assistance system 200, some or all of an information processing apparatus (e.g., a processor or a central processing unit (CPU); the information processing apparatus may be one or more microprocessors) 201, a storage apparatus (e.g., a memory) 202, a non-volatile recording medium (e.g., a non-volatile memory (e.g., a flash memory) or a non-volatile disk apparatus) 203, an external recording medium drive (e.g., a disk drive) 204, an input apparatus (e.g., a mouse, a keyboard, an image capturing apparatus, a sensor, a touch panel, or a pointing device) 206, the display/output apparatus (e.g., a display, a printer, or a speaker) 207, a communication apparatus (e.g., a communication apparatus for wired communication or a communication apparatus for wireless communication; the communication apparatus may be a network interface apparatus (network interface card (NIC)) that controls communication with another system, apparatus, terminal, or server in accordance with a predetermined protocol) 208, and an external input/output port 209 may be interconnected by an interconnecting section (e.g., a bus or a crossbar switch) 210.

A program 220a (e.g., a program for realizing the functional configuration according to the present disclosure; the sales assistance program) and various types of information 222 may be recorded on the non-volatile recording medium 203. The sales record database 231, the product information database 232, the corporation database 233, and a determination database 234 may be recorded on the non-volatile recording medium 203. Instead of what is described above, some or all of the program 220a, the various types of information 222, and the information in the various types of databases 231 to 234 described above may be acquired from the outside of what is depicted in FIG. 2, in another possible mode.

The external recording medium drive 204 can be connected with an external recording medium (e.g., a portable recording disk (a digital versatile disc (DVD) or the like), an integrated circuit (IC) card, an SD card, a non-volatile memory (e.g., a flash memory), or a portable hard disk) 205. Note that, from the external recording medium 205, the program 220a (e.g., the program for realizing the functional configuration according to the present disclosure; the sales assistance program), the various types of information 222, or the information in the various types of databases 231 to 234 may be transferred to and stored on the non-volatile recording medium 203 or the storage apparatus 202, in another possible mode. The external recording medium 205 may be used for recording programs or data handled in the information processing system 180 or the sales assistance system 200. The external recording medium drive 204 and the external recording medium 205 may be connected to the information processing system 180 or the sales assistance system 200 via a communication network, in another possible mode.

The program 220a (e.g., the program for realizing the functional configuration according to the present disclosure; the sales assistance program), the various types of information 222, or the information about the various types of databases 231 to 234 may be given through the communication apparatus 208, the external input/output port 209, or the input apparatus 206, and stored on the non-volatile recording medium 203 or the storage apparatus 202.

In order for the architecture in FIG. 2 to function as the information processing system 180, the sales assistance system 200, each functional section in the information processing system 180 or the sales assistance system 200, or a portion of each functional section in the information processing system 180 or the sales assistance system 200 (to execute one process (step) or a series of processes (steps)), the program 220a may be loaded (e.g., from the non-volatile recording medium 203) onto the storage apparatus 202. The program after being loaded is denoted by 220b in FIG. 2. Further, the information processing apparatus 201 may execute the program 220b (by using, as necessary, the various types of information 222 in the non-volatile recording medium 203 or the like, or the information about the various types of databases 231 to 234). Execution of the program 220b realizes functions of the information processing system 180, the sales assistance system 200, each functional section in the information processing system 180 or the sales assistance system 200, or a portion of each functional section in the information processing system 180 or the sales assistance system 200 (one process (step) or a series of processes (steps) is executed). At this time, various types of buffers 223 formed temporarily in the storage apparatus 202 may be used as appropriate.

### 3. Databases Used in Embodiment of Present Disclosure

Hereinbelow, a summary of each of the databases that may be used in the embodiment of the present disclosure is explained. An additional explanation is given in some cases in “4. Processes performed in embodiment of present disclosure,” in addition to the explanation here. Note that it is not essential to use the entire databases or information explained below.

By making it possible to access a database described below or information retained in the database in the embodiment of the present disclosure, information to be used for processes depicted in “4. Processes performed in embodiment of present disclosure” described later can be acquired, and information obtained in the processes can be recorded.

### 3-1. Sales Record Database

FIG. 3 depicts the internal structure of the sales record database 231. For example, information included in the sales record database 231 may be information about existing clients or new clients (candidates) collected by sales representatives or the like through sales activities. The sales record database 231 may include some information representing behaviors of the existing clients or the new clients (candidates) (e.g., web access history information).

The sales record database 231 may include client information data 301. The client information data 301 may include information about each existing client or new client (candidate). In the example in FIG. 3, the client information data 301 includes Corporation-A client information 311, Corporation-B client information 312, and Corporation-C client information 313 corresponding to existing-client Corporation A, Corporation B, and Corporation C, respectively. FIG. 3 lists information that the Corporation-A client information 311 may include. The Corporation-B client information 312 and the Corporation-C client information 313 may also include information similar to that of the Corporation-A client information 311.

The Corporation-A client information 311 may include client name information 321, client location information 322, client representative information 323 representing client-side representatives, and system user firm's representative information 329 representing sales representatives or the like for the client. Here, the system user firm is a manufacturer of target products. The Corporation-A client information 311 may include target product summary information 325 representing a summary of products owned by the client (e.g., names and the number of units of the products) and target product representative model number information 326 representing the model number of a representative product among the products owned by the client. The Corporation-A client information 311 may include equipment name information 335 which is information about each owned product and represents the names of the products as equipment, model number information 336 representing product model numbers, delivery timing information 342 representing timings when products have been delivered, note information 337 representing information about products obtained through sales activities or the like related to the products, and estimated update timing information 343 representing estimated timings of updating (re-delivery) of products. The Corporation-A client information 311 may include date-of-last-visit information 351 representing the date of the last visit to the client by a sales representative or the like and sales record information 352 which is records of sales activities input by sales representatives or the like. Note that the Corporation-A client information 311 may include not only the date-of-last-visit information 351 but also date-of-visit history information including information about the dates of visits made before the last visit.

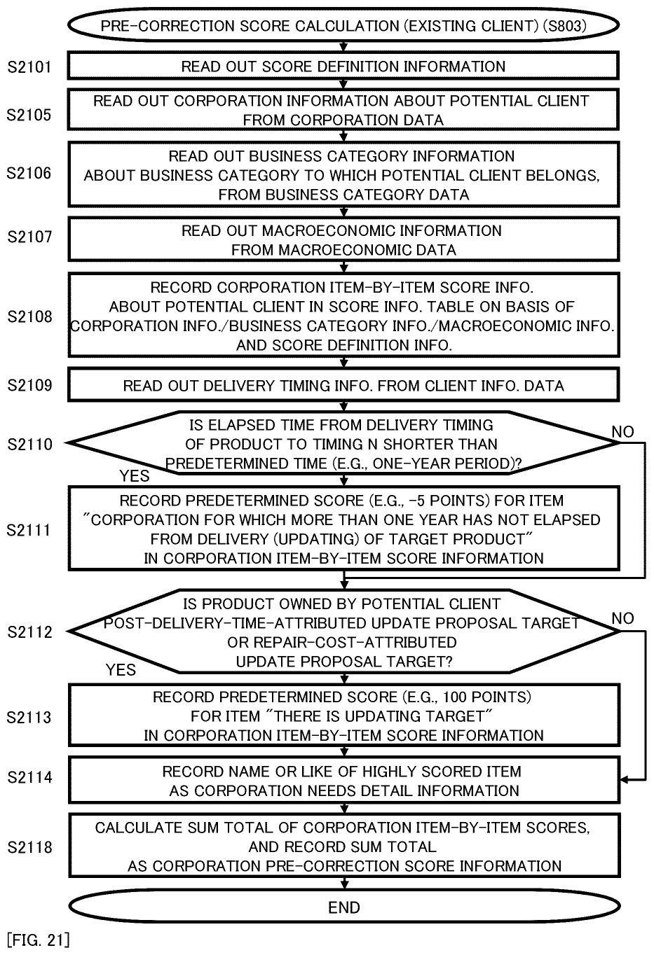

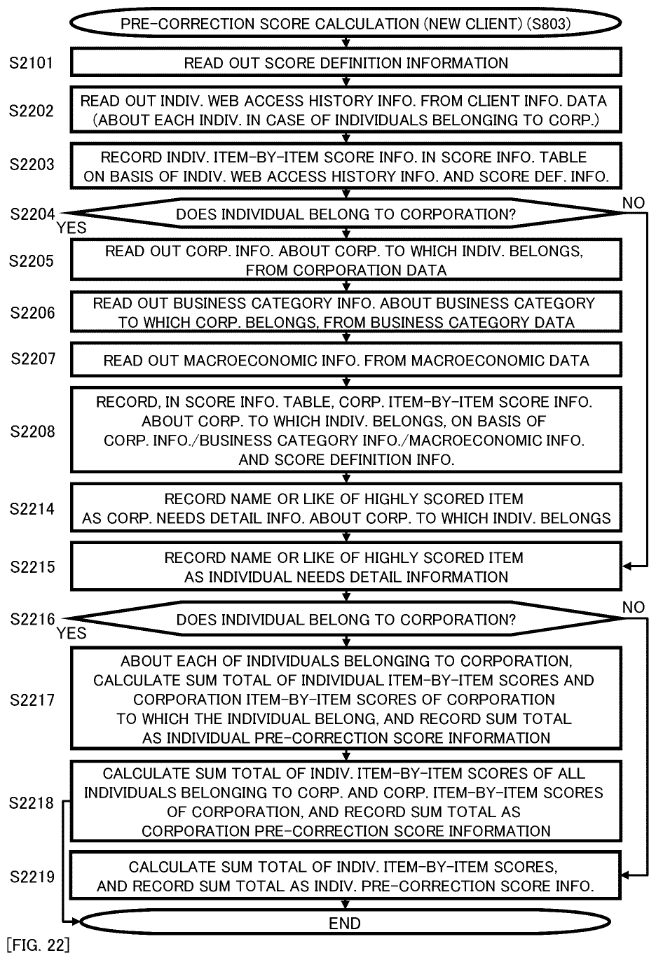

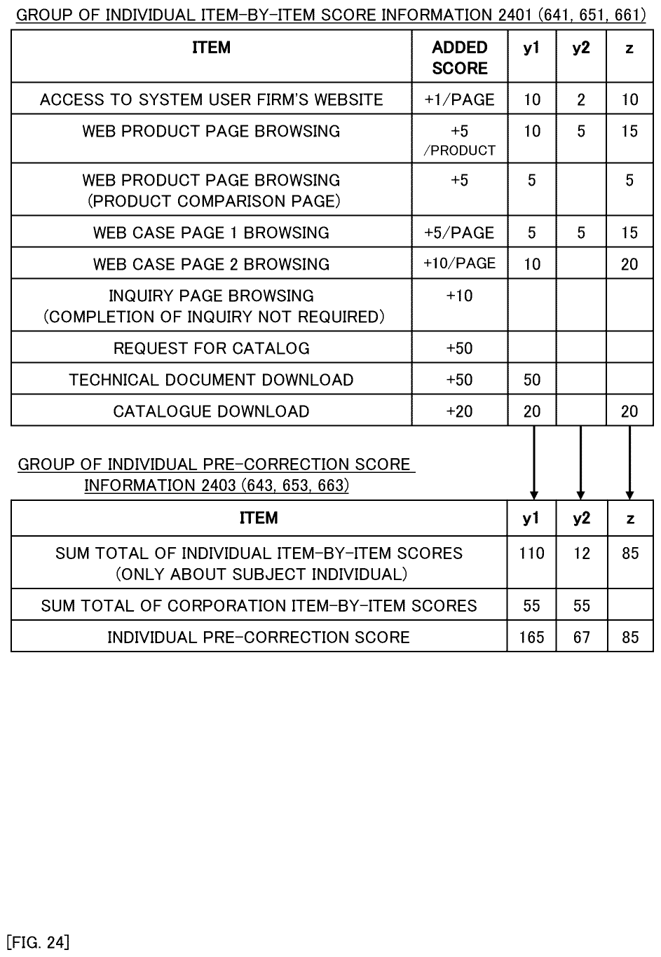

The Corporation-A client information 311 may include individual web access history information 361 about each of one or more individuals belonging to the client corporation (Corporation A). As described later using FIG. 22 and FIG. 24, the individual web access history information 361 here may be information about histories of access to webpages for providing information such as product specifications, for example. Note that, as described later using FIG. 21, if the individual web access history information 361 about each of one or more individuals belonging to the existing-client corporation is not used in calculating a pre-correction score of the existing client, the Corporation-A client information 311 may not include the individual web access history information 361.

The client information data 301 may include either or both of Corporation-Y client information 314 and Individual-z client information 315 corresponding to Corporation Y and Individual z each of which is a new client (candidate), respectively. In the example in FIG. 3, on the premise that Individual y1 and Individual y2 belong to Corporation Y, the Corporation-Y client information 314 may include Individual-y1 web access history information 371 and Individual-y2 web access history information 372. The Individual-z client information 315 may include Individual-z web access history information 381. These pieces of web access history information may be in modes similar to that of the individual web access history information 361 described before. Note that FIG. 3 depicts only the web access history information as information included in the Corporation-Y client information 314 and the Individual-z client information 315. However, if information about Corporation Y or Individual z other than the web access history information can be acquired by some approach, information similar to the information depicted about the Corporation-A client information 311 may be included in either or both of the Corporation-Y client information 314 and the Individual-z client information 315.

### 3-2. Product Information Database

FIG. 4 depicts the internal structure of the product information database 232. The product information database 232 may include product specification data 401 and client-owned-product data 402.

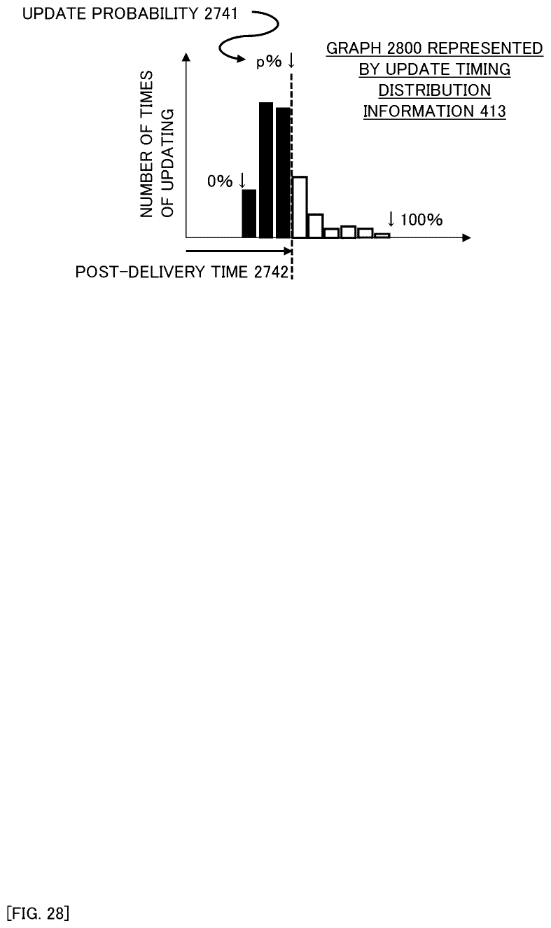

The product specification data 401 may include, as information about each product model number of products owned by clients, products that are planned to be delivered, or products to be newly delivered in updating (re-delivery) of products owned by clients, recommended update time information 411 representing a recommendation value of time that elapses from the timing of introduction (delivery) of a product to the timing of updating (re-delivery) of the product, typical installation time information 412 representing typical time that elapses from a timing when installation work of a product is started to a timing when the installation work of the product is completed (timing when the product is delivered), update timing distribution information 413 to be explained later using FIG. 28, specification information 414 representing specifications of a product, and typical maintenance expense information 415 representing typical maintenance expenses required for periodic inspections of a product. The product specification data 401 may include association information 416 representing correspondence between the model number (old model number) of a product having been used until the product is updated (re-delivered) and the model number (new model number) of a product that is expected to be used after the updating (re-delivery), when the product is to be updated (re-delivered).

The client-owned-product data 402 may include owned-product information about each existing client. In the example in FIG. 4, the client-owned-product data 402 may include Corporation-A-owned-product information 421, Corporation-B-owned-product information 422, and Corporation-C-owned-product information 423 corresponding to existing-client Corporation A, Corporation B, and Corporation C, respectively. Whereas FIG. 4 depicts information included in the Corporation-A-owned-product information 421, the Corporation-B-owned-product information 422 and the Corporation-C-owned-product information 423 may also include similar information.

The Corporation-A-owned-product information 421 may include, as information about each product owned by the client, installation location environment information 431 representing the environmental status of a location where a product is installed and maintenance status information 432 representing the maintenance status of the product. Note that, as depicted in FIG. 1, by causing information about products being operationally used to be transmitted from the existing-client-owned system of Corporation A and received by the information processing system 180 (sales assistance system 200), the installation location environment information 431 and the maintenance status information 432 may be updated on the basis of the information about the products being operationally used received by the information processing system 180 (sales assistance system 200). Alternatively, transmission and reception of information about products being operationally used may not performed, and information obtained at the time of delivery of products or information obtained through sales activities by sales representatives or the like after the delivery may be used to set the installation location environment information 431 and the maintenance status information 432.

Note that, if information about products owned by a new client (candidate) is obtained by some approach, owned-product information about the new client (candidate) having types of information similar to those of the Corporation-A-owned-product information 421 may also be included in the client-owned-product data 402.

### 3-3. Corporation Database

FIG. 5 depicts the internal structure of the corporation database 233. The corporation database 233 may include corporation data 501 including corporation information about each corporation, business category data 502 including business category information about each business category, and macroeconomic data 503 including macroeconomic information about each country or region, for example.

In the example in FIG. 5, the corporation data 501 includes Corporation-A corporation information 511, Corporation-B corporation information 512, and Corporation-C corporation information 513 corresponding to existing-client Corporation A, Corporation B, and Corporation C. In the example in FIG. 5, the corporation data 501 includes Corporation-Y corporation information 514 corresponding to new-client (candidate) Corporation Y. Whereas the example in FIG. 5 depicts information that can be included in the Corporation-A corporation information 511, the Corporation-B corporation information 512, the Corporation-C corporation information 513, and the Corporation-Y corporation information 514 may also include similar types of information.

The Corporation-A corporation information 511 may include business category classification information 521 representing a business category to which the corporation belongs, office location information 522 representing the location of an office and plants of the corporation, performance information 523 representing corporation performance (e.g., sales, operating profit, and net income), activity characteristics information 524 representing characteristics of activities that the corporation is currently performing or will perform in the future (e.g., actively promoting capital investment, devoting itself to the improvement of business efficiency, and being aware of Sustainable Development Goals (SDGs) as a task), number-of-employees information 525 representing the number of employees of the corporation and its changes, and financial result timing information 526 representing the financial result timing of the corporation. In addition to the information described above, for example, the Corporation-A corporation information 511 may include information similar to IR information, which is information for investors, and information about the corporation published on the Internet.

The business category data 502 may include business category information representing the status of each business category to which a corporation can belong. For example, the business category information may include information about the economic situation of the business category and information about the status of capital investment in the industry of the business category.

The macroeconomic data 503 may include macroeconomic information representing the status of the macro economy of each entire country or region. The macroeconomic information may include macroeconomic indicators.

Information included in the corporation database 233 may be based on information that the information processing system 180 (sales assistance system 200) acquires from the external database 193 or the secondary information source 194 depicted in FIG. 1 via a network or the like. Alternatively, instead of the information processing system 180 (sales assistance system 200) locally building the corporation database 233, every time such information as depicted in FIG. 5 becomes necessary, the information processing system 180 (sales assistance system 200) may acquire a necessary amount of information from the external database 193 or the secondary information source 194 via a network, in another possible mode.

### 3-4. Determination Database

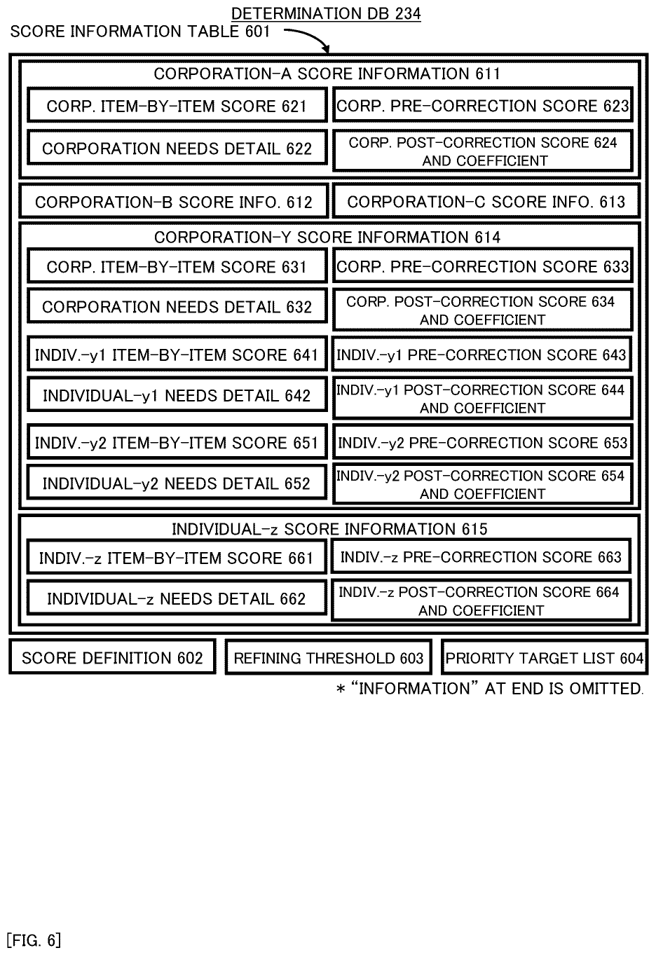

FIG. 6 depicts the internal structure of the determination database 234. The determination database 234 may include a score information table 601 including score information about each potential client, score definition information 602 representing definition information for calculating pre-correction scores described later, refining threshold information 603 representing threshold information about post-correction scores described later, and priority target list information 604 representing potential clients determined as priority potential clients.

In the example in FIG. 6, the score information table 601 may include Corporation-A score information 611, Corporation-B score information 612, and Corporation-C score information 613 for existing-client Corporation A, Corporation B, and Corporation C, respectively. The score information table 601 may include Corporation-Y score information 614 and Individual-z score information 615 for new-client (candidate) Corporation Y and Individual z, respectively.

Whereas the example in FIG. 6 depicts information included in the Corporation-A score information 611 for existing-client Corporation A, score information about each of existing-client Corporation A, Corporation B, and Corporation C may have types of information similar to each other.

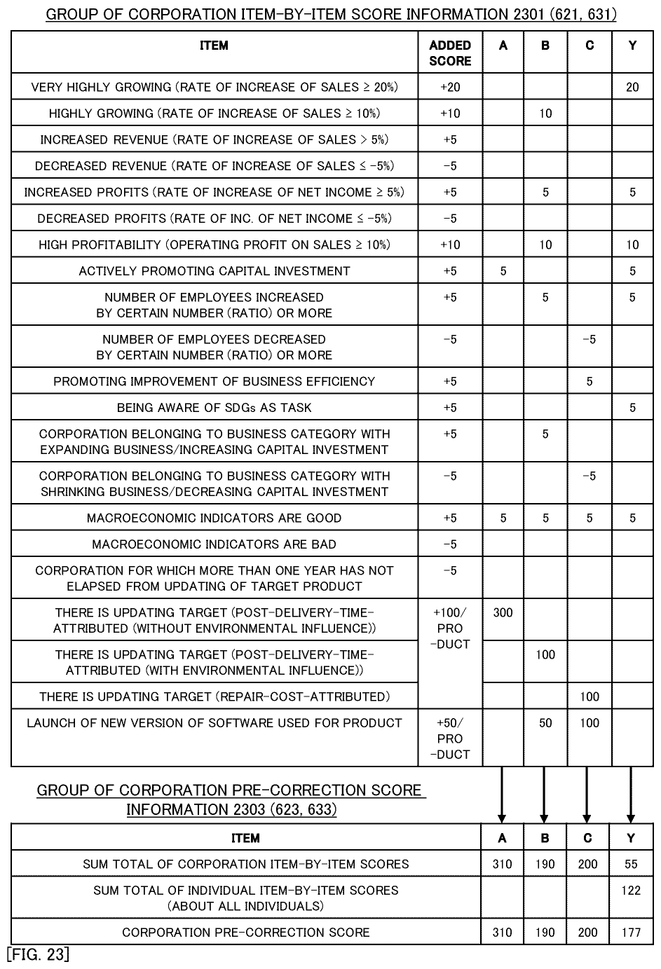

The Corporation-A score information 611 may include corporation item-by-item score information 621 representing item-by-item scores about the corporation like the one to be explained later using FIG. 23, corporation needs detail information 622 representing the content of items that contribute high scores to the item-by-item scores of the corporation, corporation pre-correction score information 623 representing a pre-correction score of the corporation like the one to be explained later using the lower portion of FIG. 23, and corporation post-correction score information 624 representing a post-correction score of the corporation (which may also include coefficient information reflecting a priority measure for the corporation).

In addition to corporation item-by-item scores 631, corporation needs detail information 632, corporation pre-correction score information 633, and corporation post-correction score information 634 (which have roles similar to those of the information included in the score information about existing-client Corporation A), the Corporation-Y score information 614 about new-client (candidate) Corporation Y may include information about each of Individual y1 and Individual y2 belonging to Corporation Y. The Corporation-Y score information 614 may include, as information about Individual y1, Individual-y1 item-by-item score information 641 representing item-by-item scores of the individual like the one to be explained later using FIG. 24, Individual-y1 needs detail information 642 representing the content of items that contribute high scores to the item-by-item scores of the individual, Individual-y1 pre-correction score information 643 representing a pre-correction score of the individual like the one to be explained later using the lower portion of FIG. 24, and Individual-y1 post-correction score information 644 representing a post-correction score of Individual y1 (which may also include coefficient information reflecting a priority measure for the individual). The Corporation-Y score information 614 may include, as information about Individual y2 as well, types of information similar to those of the above-described information about Individual y1.

The Individual-z score information 615 about new-client (candidate) Individual z may include Individual-z item-by-item score information 661, Individual-z needs detail information 662, Individual-z pre-correction score information 663, and Individual-z post-correction score information 664 (which have roles similar to those of the information about Individual y1 explained in the description above).

The score definition information 602 may represent the content of items and rules about score addition for each item depicted in FIG. 23 and FIG. 24. The content of the score definition information 602 may be preset by an administrator of the information processing system 180 (sales assistance system 200) or a sales representative or the like. The administrator of the information processing system 180 (sales assistance system 200) or the sales representative or the like may input, to the information processing system 180 (sales assistance system 200), an instruction to change the content of the preset score definition information 602.

The refining threshold information 603 may represent a threshold for a post-correction score calculated for each potential client, when it is determined whether or not each of potential clients is a priority potential client. For example, in a case where a post-correction score of a certain potential client is equal to or greater than the threshold or exceeds the threshold, the certain potential client may be assessed as a priority potential client. Note that, in a case where an approach in which certain potential clients whose ranks of post-correction scores are within a certain range are assessed as priority potential clients is used, there may not be the refining threshold information 603 described above. Note that the administrator of the sales assistance system 200 or the sales representative or the like may input the refining threshold information 603 to the sales assistance system 200 in advance. The administrator of the sales assistance system 200 or the sales representative or the like may give the sales assistance system 200 an instruction to change the refining threshold information 603 that has been set until then.

The priority target list information 604 represents potential clients determined as priority potential clients corresponding to the certain timing 160. Note that, in a case where a scheme in which priority potential clients corresponding to the certain timing 160 are determined using a post-correction score corresponding to each of the potential clients is used when the priority potential client list 170 is to be displayed or output, there may not be the priority target list information 604 described above.

### 4. Processes Performed in Embodiment of Present Disclosure

Processes performed in the embodiment of the present disclosure are explained. Note that it is not essential to realize the entire functional configuration explained below and perform all of the processes explained below. There may be a sales assistance method, a sales assistance program, and a sales assistance system for realizing part of the functional configuration explained below and performing some of the processes.

### 4-1. Main Routine

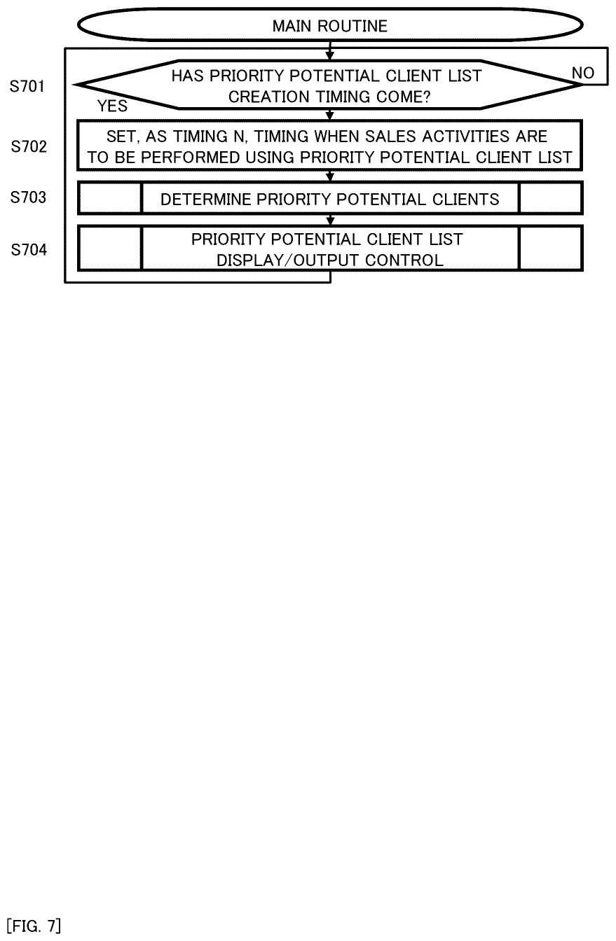

FIG. 7 depicts a flowchart of a main routine of the sales assistance method or the sales assistance program executed in the embodiment of the present disclosure.

At Step 701 in FIG. 7, the sales assistance system 200 assesses whether or not a timing of creation of (information to be used to display or output) the priority potential client list 170 in sales activities of the certain timing 160 has come. Alternatively, an administrator of the information processing system 180 (sales assistance system 200) or a sales representative or the like may give the information processing system 180 (sales assistance system 200) an instruction requesting to create (information to be used to display or output) the priority potential client list 170 in sales activities of the certain timing 160. If an assessment result of Step 701 is YES, the control proceeds to Step 702. If an assessment result of Step 701 is NO, the assessment process of Step 701 is repeated.

Note that intervals between “certain timings 160,” which are timings of sales activities using the priority potential client list 170, may be set shorter than time between an estimated consideration period 1046 explained later and a budget formulation timing 1036 explained later. For example, intervals between the “certain timings 160” may be set to one-month periods (i.e., the “certain timings 160” may be set such that they come once every month like August 2023, September 2023, . . . ). By setting intervals between the “certain timing 160” relatively short, it becomes possible to control sales activities meticulously.

At Step 702 in FIG. 7, the sales assistance system 200 manages, as a “timing N,” a “certain timing 160,” which is a timing when sales activities using the priority potential client list 170 are to be performed. In the following explanation, the “certain timing 160” is expressed as the “timing N” in some cases.

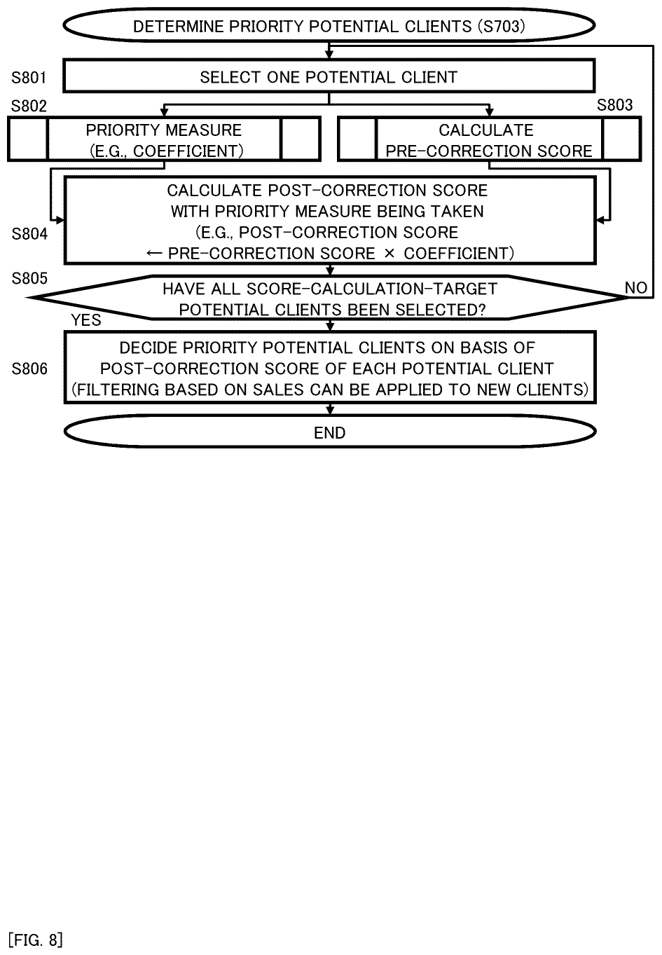

At Step 703 (priority potential client determination step) in FIG. 7, (a priority potential client determining section as a functional section of) the sales assistance system 200 determines priority potential clients to be treated as priority targets of sales activities to be performed at the timing N. Details of Step 703 are explained later using FIG. 8.

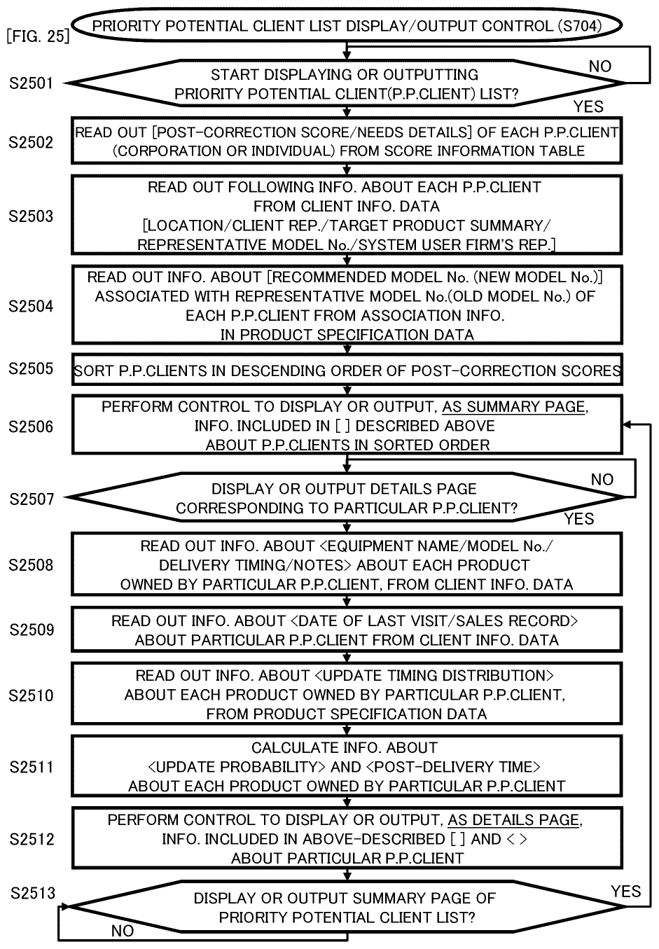

At Step 704 (priority potential client list display/output control step) in FIG. 7, (a priority potential client list display/output control section as a functional section of) the sales assistance system 200 performs control such that the priority potential client list 170 representing information about priority potential clients in sales activities of the timing N is displayed or output. Details of Step 704 are explained later using FIG. 25. Note that the priority potential client list 170 may be displayed or output by the display/output apparatus 207 controlled by the information processing system 180 (sales assistance system 200), or (after information included in the priority potential client list 170 is transmitted from the information processing system 180 (sales assistance system 200) and received by the sales representative terminal 181) may be displayed or output by a display/output apparatus controlled by the sales representative terminal 181.

Note that the timing when Step 703 is executed and the timing when Step 704 is executed may be close to each other, or may have a certain length of a temporal difference. That is, it is also possible that Step 703 is executed in advance and, after information required for displaying or outputting the priority potential client list 170 for the timing N is prepared in advance, Step 704 is executed at a timing when a sales representative or the like refers to the priority potential client list 170 for the timing N.

### 4-2. Priority Potential Client Determination

FIG. 8 depicts a flowchart inside Step 703 (priority potential client determination step) in FIG. 7.

At Step 801 in FIG. 8, (the priority potential client determining section as a functional section of) the sales assistance system 200 selects any one of potential clients as a target (consideration target) to be handled in the subsequent steps in FIG. 8. For example, regarding existing clients, a corporation (or an individual not belonging to a corporation) to which a product is introduced (or delivered) or where a product is updated (to which a product is re-delivered) may be treated as a selection target (consideration target) at Step 801. Meanwhile, regarding new clients (candidates), not only a corporation or an individual not belonging to a corporation but also an individual belonging to a corporation may be treated as a selection target (consideration target) at Step 801. After Step 801, Step 802 and Step 803 are executed together. (The order of execution of Step 802 and Step 803 may be any order. Step 802 and Step 803 may be executed concurrently.)

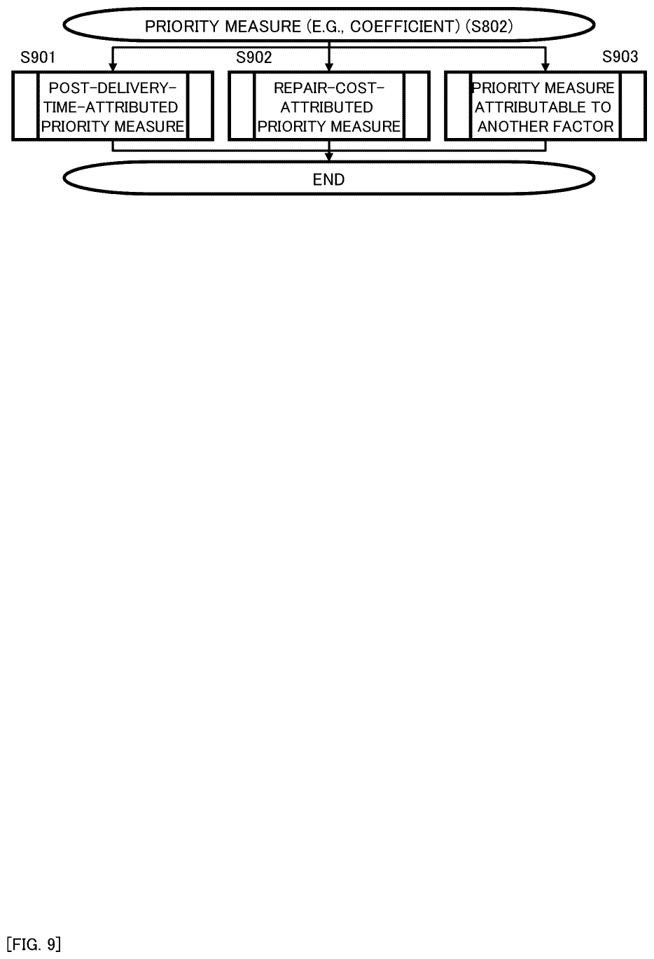

At Step 802 in FIG. 8, the sales assistance system 200 (priority potential client determining section) assesses whether or not there is some reason (reason for prioritization) for treating a consideration-target potential client as one suitable for a sales representative or the like to perform sales activities at the timing N. For example, if there is any one reason for prioritization about any one of products owned by the consideration-target potential client (or about the potential client itself), the consideration-target potential client may be treated as a target of a priority measure. In a case where there is some reason for treating the consideration-target potential client as one suitable for a sales representative or the like to perform sales activities at the timing N, the sales assistance system 200 (priority potential client determining section) treats the potential client such that the potential client is likely to be determined as a priority potential client at the timing N. For example, as a priority measure to treat a potential client such that the potential client is likely to be determined as a priority potential client at the timing N, a coefficient used for obtaining a post-correction score from a pre-correction score (described later) corresponding to the potential client may be set relatively large. Details of Step 802 are explained later using FIG. 9.

At Step 803 (pre-correction score calculation step) in FIG. 8, the sales assistance system 200 (a pre-correction score calculating section as one functional section included in the priority potential client determining section) calculates a pre-correction score described later of the consideration-target potential client. Note that different pre-correction score calculation approaches may be used for a case where the potential client is an existing client and for a case where the potential client is a new client (candidate). Details of Step 803 for an existing client are explained later using FIG. 21. Details of Step 803 for a new client (candidate) are explained later using FIG. 22. After execution of both Step 802 and Step 803 has been completed, the control proceeds to Step 804.

At Step 804 in FIG. 8, the sales assistance system 200 (priority potential client determining section) calculates a post-correction score on the basis of the priority measure determined at Step 802 and the pre-correction score determined at Step 803. That is, the sales assistance system 200 (priority potential client determining section) calculates the post-correction score by taking the priority measure for the pre-correction score. For example, the sales assistance system 200 (priority potential client determining section) may obtain the post-correction score by multiplying the coefficient set at Step 802 and the pre-correction score set at Step 803. Alternatively, the sales assistance system 200 (priority potential client determining section) may obtain the post-correction score by determining the sum of a to-be-added value set at Step 802 and the pre-correction score set at Step 803 (in a case where the priority measure at Step 802 is setting of the to-be-added value).

At Step 805 in FIG. 8, the sales assistance system 200 (priority potential client determining section) assesses whether or not all of potential clients which are the targets of calculation of post-correction scores have been selected at Step 801. If an assessment result of Step 805 is YES, the control proceeds to Step 806. If an assessment result of Step 805 is NO, the control proceeds to Step 801, and the next potential client is selected (treated as a consideration target).

At Step 806 (priority potential client specifying step) in FIG. 8, the sales assistance system 200 (a priority potential client specifying section, which is one functional section included in the priority potential client determining section) decides priority potential clients at the timing N on the basis of the post-correction score corresponding to each of the potential clients. For example, the sales assistance system 200 (priority potential client specifying section) may decide, as priority potential clients at the timing N, potential clients having post-correction scores which are equal to or greater than the threshold represented by the refining threshold information 603 or post-correction scores exceeding the threshold. Alternatively, the sales assistance system 200 (priority potential client specifying section) may decide, as priority potential clients at the timing N, a predetermined number of potential clients in descending order of post-correction scores, without using the refining threshold information 603. Alternatively, the sales assistance system 200 (priority potential client specifying section) may decide, as priority potential clients at the timing N, potential clients that are included in a predetermined number of potential clients in descending order of post-correction scores and that have post-correction scores equal to or greater than the threshold represented by the refining threshold information 603 or post-correction scores exceeding the threshold.

In assessment as to whether or not a new client (candidate) is to be decided as a priority potential client at the timing N, the sales assistance system 200 (priority potential client specifying section) may further use, as an additional condition (filtering condition), the fact that performance (e.g., sales) represented by the performance information 523 related to the new client (candidate) satisfies a predetermined condition (e.g., the sales is equal to or greater than a threshold, or is greater than the threshold).

The sales assistance system 200 (priority potential client specifying section) may record, in the priority target list information 604 in the determination database 234, information to specify the priority potential clients of the timing N.

By the process represented by the flowchart in FIG. 8 described above, the pre-correction score, the numerical value representing the priority measure (e.g., the coefficient or the to-be-added value), and the post-correction score are used for each potential client. Accordingly, circumstances that can be taken into consideration in the process of determining priority potential clients are quantified. Accordingly, the process of determining priority potential clients at the timing N is defined clearly. In addition, the post-correction scores make it easier for a sales representative or the like to recognize the order of priority of sales activities at the timing N.

Note that the timing when the post-correction score of each potential client is calculated at Steps 801 to 805 and the timing when priority potential clients at the timing N are decided at Step 806 need not be close to each other. That is, the sales assistance system 200 (1) may execute Steps 801 to 805 and Step 806 at timings close to each other in a time series, (2) may execute Step 806 and Step 704 (priority potential client list display/output control step) at timings close to each other in a time series, or (3) may execute Steps 801 to 805, Step 806, and Step 704 (priority potential client list display/output control step) at timings apart from each other in a time series.

### 4-2-1. Priority Measure

FIG. 9 depicts a flowchart inside Step 802 in FIG. 8. The order of execution of Step 901, Step 902, and Step 903 depicted in FIG. 9 may be any order. In addition, these steps may be executed concurrently.

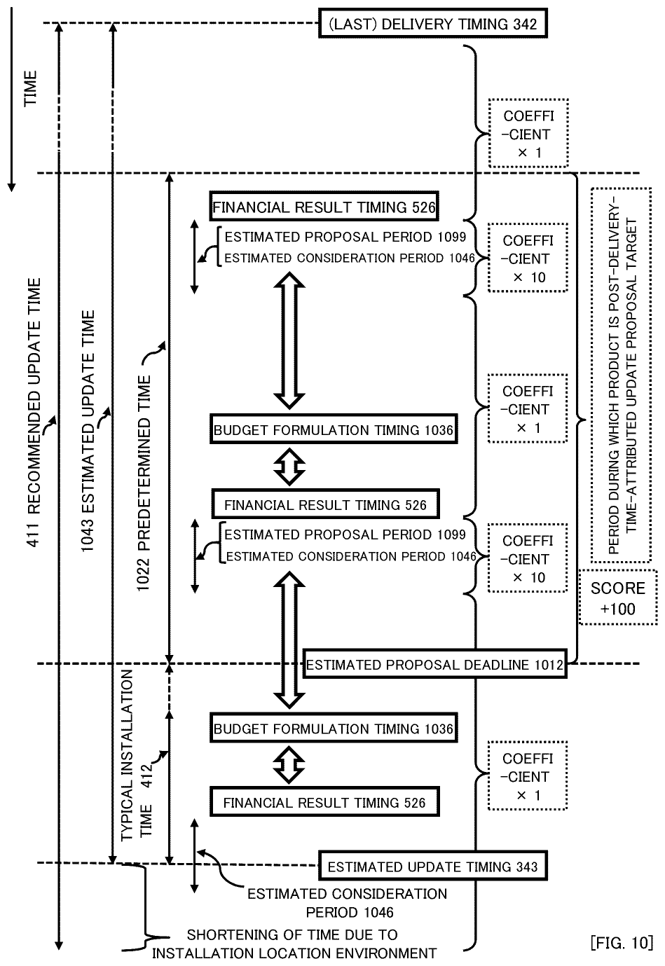

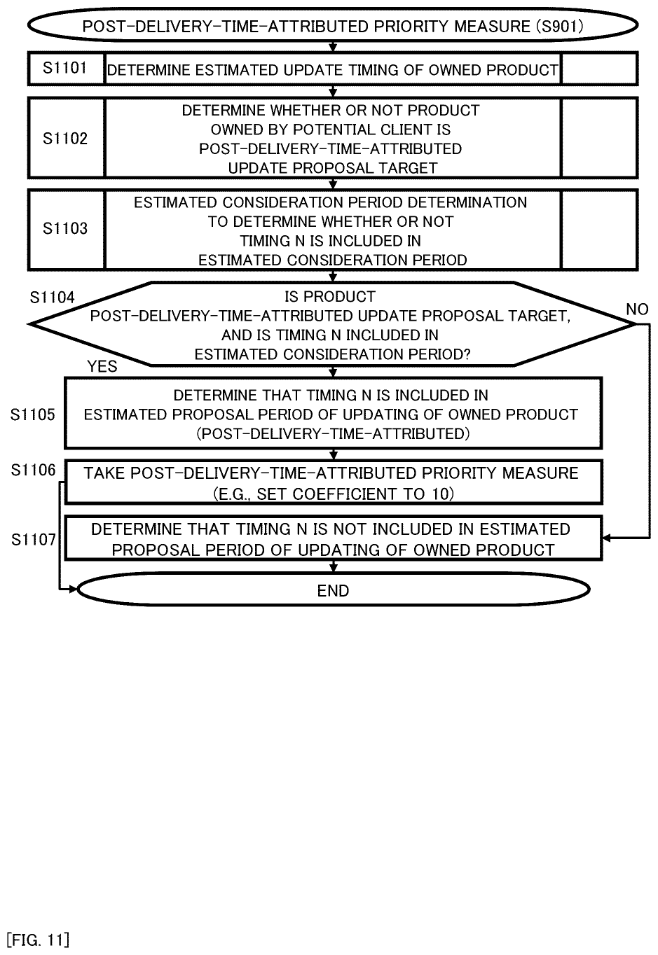

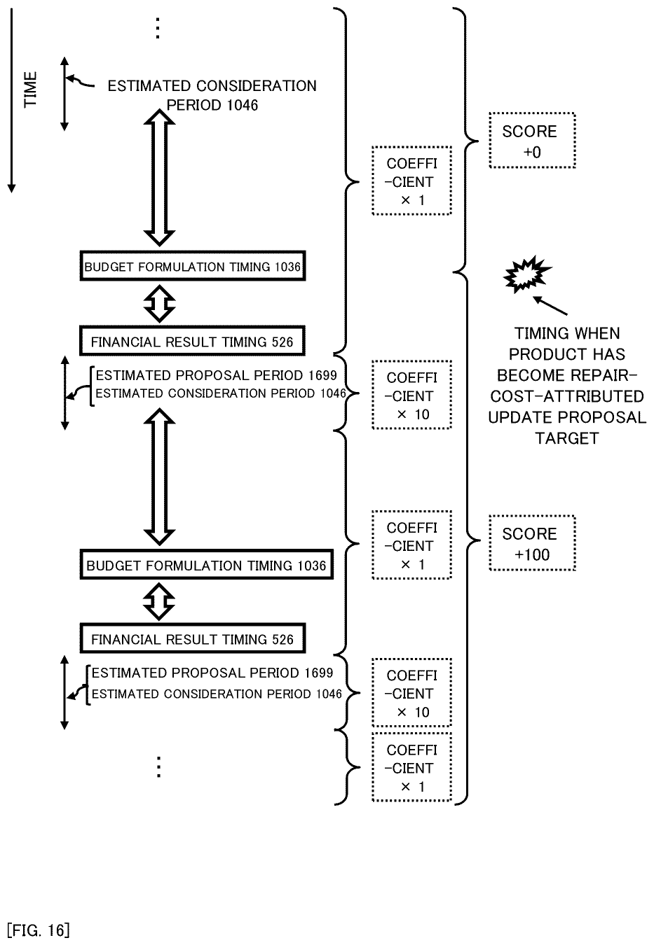

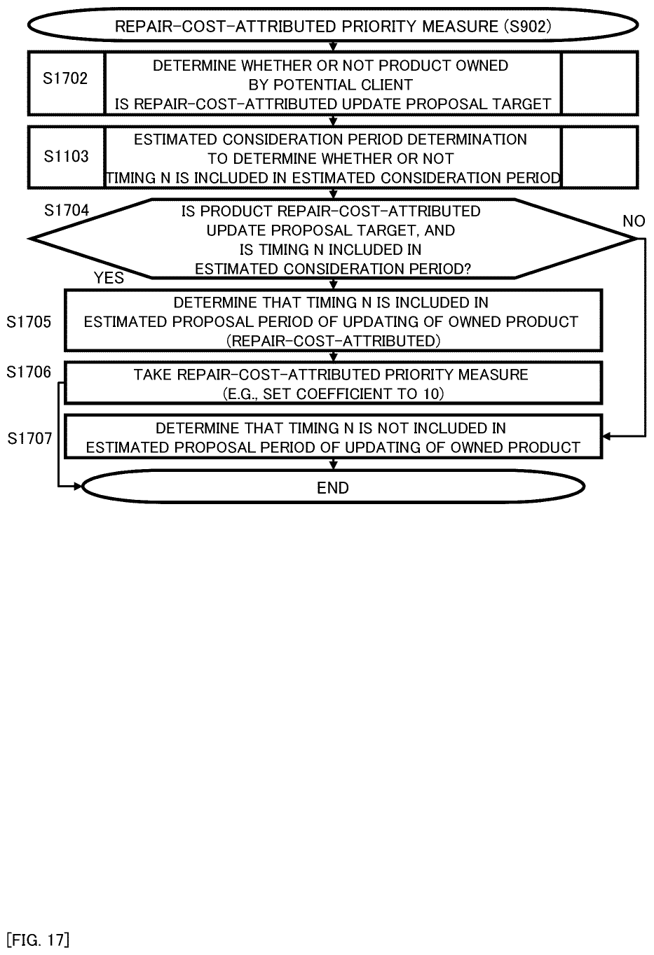

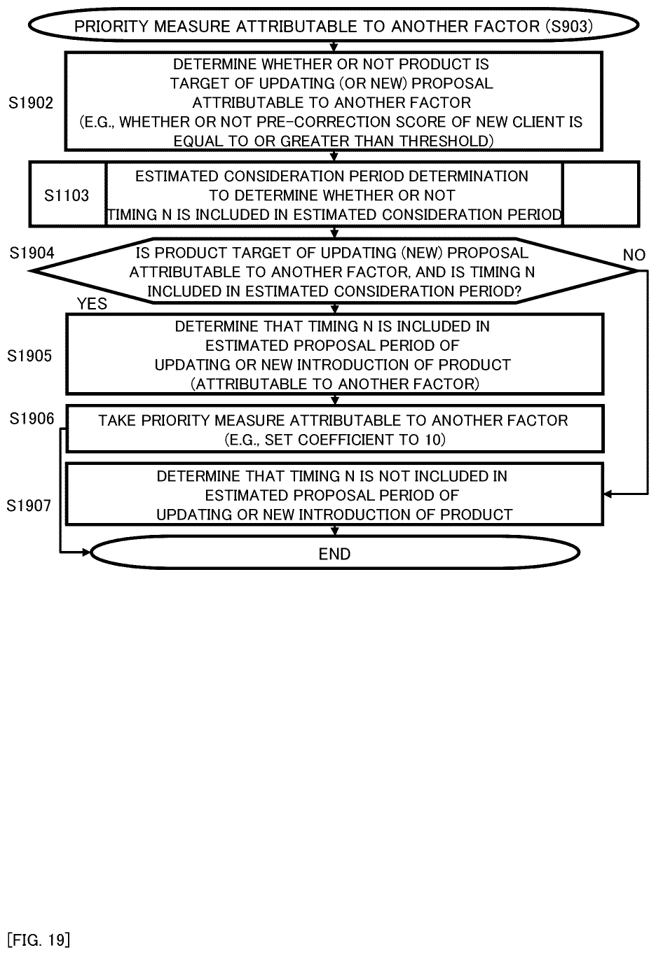

Step 901 in FIG. 9 considers a post-delivery-time-attributed priority measure. Details of Step 901 are explained later using FIG. 10 and FIG. 11. Step 902 in FIG. 9 considers a repair-cost-attributed priority measure. Details of Step 902 are explained later using FIG. 16 and FIG. 17. Step 903 in FIG. 9 considers a priority measure attributable to another factor which is other than post-delivery time and repair cost. Details of Step 903 are explained later using FIG. 19.

Step 901 and Step 902 are executed for existing clients owning products that may be updated (re-delivered) at or after the timing N. Note that Step 901 or Step 902 may be executed even for a new client (candidate) if the new client (candidate) has a product that may be updated (re-delivered) at or after the timing N and the sales assistance system 200 can acquire information about the product by some approach.

Step 903 is executed for new clients (candidates). Note that Step 903 may be executed even for existing clients.

### 4-2-1-1. Post-Delivery-Time-Attributed Priority Measure

FIG. 10 depicts various types of timings, various types of periods, and various types of time handled in a post-delivery-time-attributed priority measure consideration process performed at Step 901 in FIG. 9, and also depicts a mode of score addition to a pre-correction score and a mode of coefficient setting as a post-delivery-time-attributed priority measure.

FIG. 11 depicts a flowchart of the post-delivery-time-attributed priority measure consideration process performed at Step 901 in FIG. 9. The flowchart in FIG. 11 is explained with reference to FIG. 10.

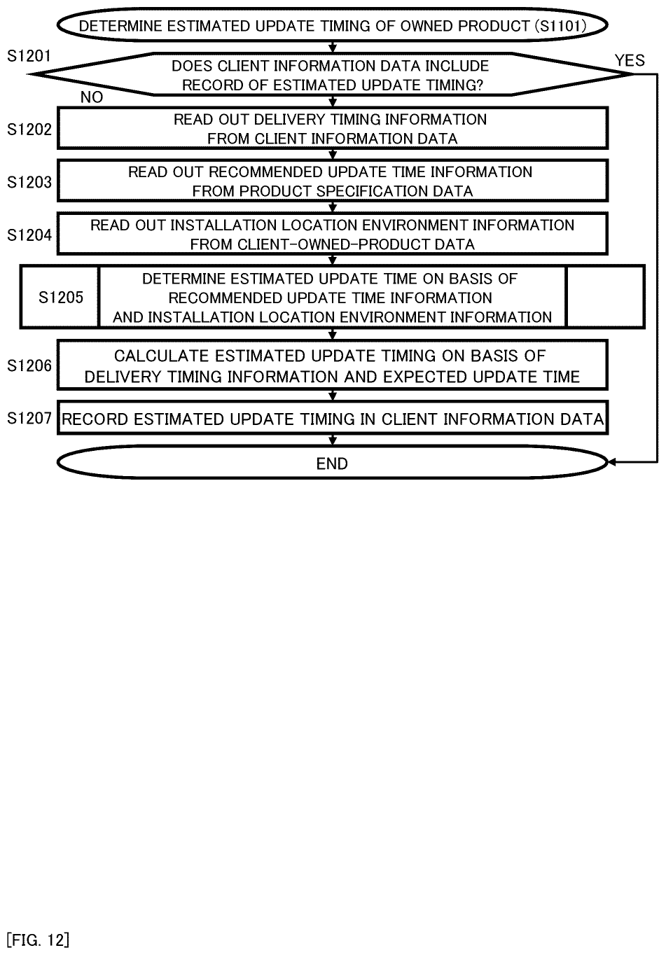

At Step 1101 (estimated update timing determination step) in FIG. 11, the sales assistance system 200 (an estimated update timing determining section, which is one functional section included in the priority potential client determining section) determines the estimated update timing (information) 343, which is an estimated timing when a product owned by a potential client is updated (re-delivered). Regarding the example in FIG. 10, the sales assistance system 200 (estimated update timing determining section) determines the estimated update timing (information) 343 on the basis of the delivery timing (information) 342 which is the last delivery timing of the product owned by the potential client, the recommended update time (information) 411 which is a value recommended as time between delivery and updating (re-delivery) of a model number of the product, and an adjustment (update-time time reduction) according to the environmental status of a location where the product is installed. Details of Step 1101 (estimated update timing determination step) are explained later using FIG. 12.

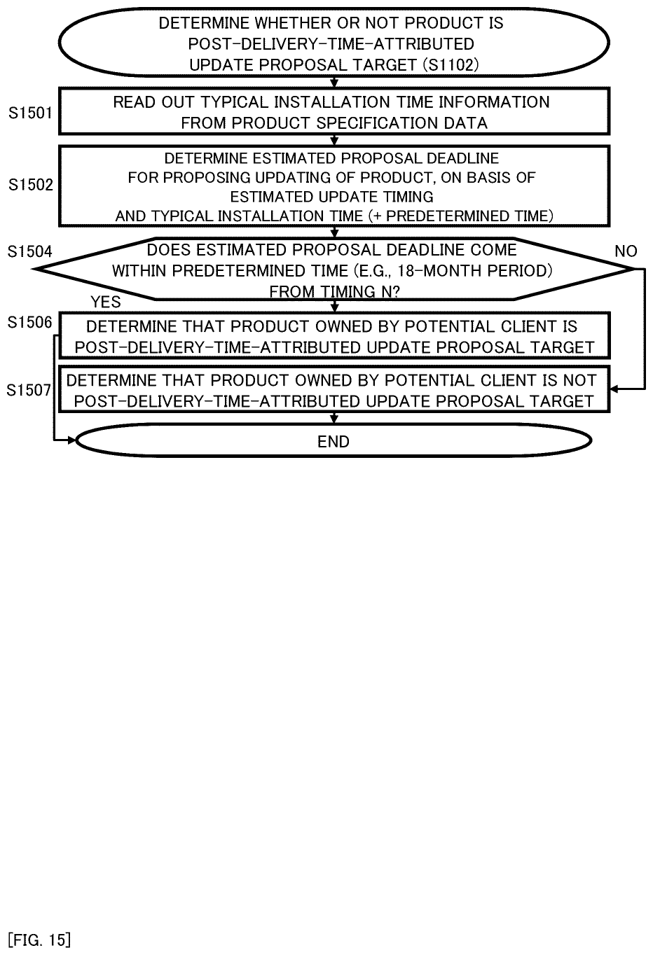

At Step 1102 in FIG. 11, the sales assistance system 200 (priority potential client determining section) determines whether or not the product owned by the potential client is a post-delivery-time-attributed update proposal target. Regarding the example in FIG. 10, the sales assistance system 200 (priority potential client determining section) determines an estimated proposal deadline 1012, which is an estimated timing of a deadline for a sales representative or the like to propose updating (re-delivery) of the product to the potential client, on the basis of the estimated update timing (information) 343 of the product owned by the potential client and the typical installation time (information) 412, which is time taken from the start of installation work of the product to the completion of the installation work (to the delivery of the product) (and also on the basis of a predetermined time margin in some cases). That is, if the potential client makes a decision by the estimated proposal deadline 1012 to update the product (make the product re-delivered), it can be expected that the updating (re-delivery) of the product is completed in time for the estimated update timing (information) 343. The sales assistance system 200 (priority potential client determining section) determines a period during which the product owned by the potential client is a post-delivery-time-attributed update proposal target, on the basis of the estimated proposal deadline 1012 and predetermined time 1022 (e.g., 18-month period). As depicted in FIG. 10, the sales assistance system 200 (priority potential client determining section) may set the period during which the product is a post-delivery-time-attributed update proposal target to a period that has a duration of the predetermined time 1022 (e.g., 18-month period) and that ends at the estimated proposal deadline 1012. The period is determined in this manner because a timing when a sales representative or the like proposes updating (re-delivery) of the product to the potential client is desirably before the estimated proposal deadline 1012; meanwhile, even if updating (re-delivery) of the product is proposed at a time point which is excessively earlier than the estimated proposal deadline 1012 in a time series, it is unlikely that such a proposal leads the potential client to make a decision to update the product (make the product re-delivered). Further, the sales assistance system 200 (priority potential client determining section) determines whether or not the timing N is included in the period during which the product owned by the potential client is a post-delivery-time-attributed update proposal target. Details of Step 1102 are explained later using FIG. 15.

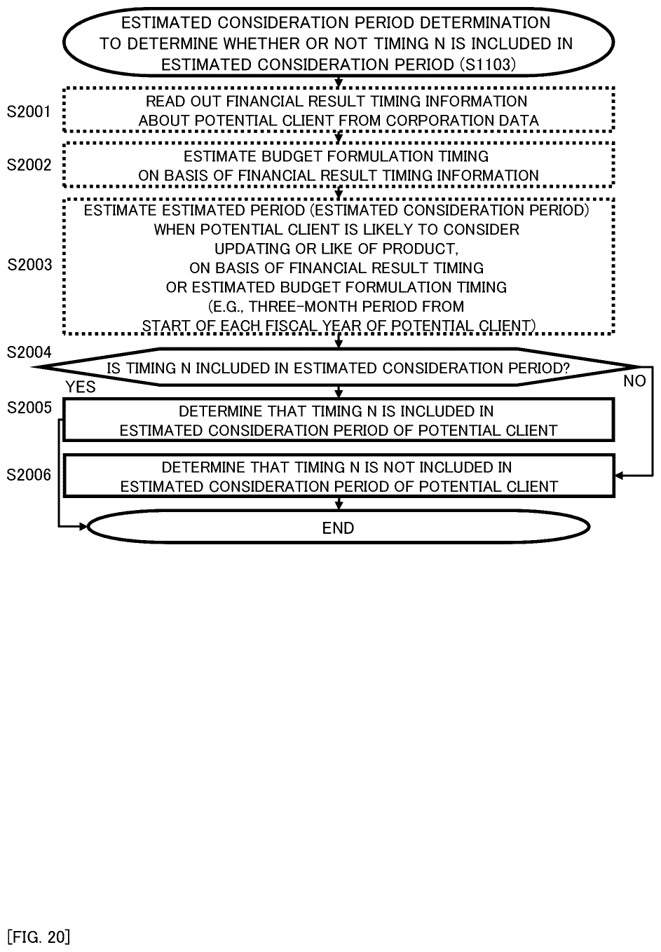

At Step 1103 (estimated consideration time determination step) in FIG. 11, the sales assistance system 200 (an estimated consideration time determining section, which is one functional section included in the priority potential client determining section) determines whether or not the timing N is included in the estimated consideration period 1046, which is an estimated timing when the potential client is likely to consider introduction (delivery) or updating (re-delivery) of the product. Regarding the example in FIG. 10, the sales assistance system 200 (estimated consideration time determining section) determines the budget formulation timing 1036, which is an estimated timing when the potential client formulates a budget, on the basis of the financial result timing (information) 526 of the potential client, and determines the estimated consideration period 1046 on the basis of the budget formulation timing 1036. For example, the estimated consideration period 1046 may be a predetermined period of a fiscal year of the potential client (e.g., the first three-month period of the fiscal year). The sales assistance system 200 (estimated consideration time determining section) determines whether or not the timing N is included in any of the estimated consideration periods 1046. Details of Step 1103 are explained later using FIG. 20.

At Step 1104 (part of the estimated proposal period determination step; also part of a post-delivery-time-attributed estimated proposal period determination step) in FIG. 11, the sales assistance system 200 (an estimated proposal period determining section or a post-delivery-time-attributed estimated proposal period determining section, which is one functional section included in the priority potential client determining section) determines whether or not the timing N is included in an estimated proposal period 1099, which is a period estimated as being suitable for a sales representative or the like to propose updating (re-delivery) of the product to the potential client, in order to update (complete re-delivery of) the product at the estimated update timing (information) 343. Regarding the example in FIG. 10, the sales assistance system 200 (estimated proposal period determining section or post-delivery-time-attributed estimated proposal period determining section) determines, as the estimated proposal period 1099, a period during which the product owned by the potential client is a post-delivery-time-attributed update proposal target and which is the estimated consideration period 1046. That is, from both the perspective of completing updating (re-delivery) of the product in time for the estimated update timing (information) 343 and the perspective of making it easier for the potential client to make a decision to update (complete re-delivery of) the product, the estimated proposal period 1099 is suitable as a timing when a sales representative or the like proposes updating (re-delivery) of the product to the potential client. The sales assistance system 200 (estimated proposal period determining section or post-delivery-time-attributed estimated proposal period determining section) assesses whether or not the timing N is included in any of the estimated proposal periods 1099. If an assessment result of Step 1104 is YES, the control proceeds to Step 1105. If an assessment result of Step 1104 is NO, the control proceeds to Step 1107.

At Step 1105 (part of the estimated proposal period determination step; also part of the post-delivery-time-attributed estimated proposal period determination step) in FIG. 11, the sales assistance system 200 (estimated time-attributed estimated proposal period determining section) determines that the timing N corresponding to the priority potential client list 170 is included in the estimated proposal period 1099 (attributable to post-delivery time) of updating (re-delivery) of the product owned by the consideration-target potential client. After Step 1105, the control proceeds to Step 1106.

At Step 1106 (priority measure step) in FIG. 11, the sales assistance system 200 (a priority measure section, which is one functional section included in the priority potential client determining section) takes a post-delivery-time-attributed priority measure about the consideration-target potential client. For example, the sales assistance system 200 (priority measure section) may set the value of a coefficient which is about the consideration-target potential client and for obtaining a post-correction score from a pre-correction score to 10. That is, if the timing N is included in a period with “COEFFICIENT×10” in FIG. 10, the coefficient about the consideration-target potential client may be set to 10.

At Step 1107 (part of the estimated proposal period determination step; also part of the post-delivery-time-attributed estimated proposal period determination step) in FIG. 11, the sales assistance system 200 (estimated time-attributed estimated proposal period determining section) determines that the timing N corresponding to the priority potential client list 170 is not included in the estimated proposal period 1099 (attributable to post-delivery time) of updating (re-delivery) of the product owned by the consideration-target potential client. In this case, for example, the value of a coefficient which is about the consideration-target potential client and for obtaining a post-correction score from a pre-correction score may be set to 1. That is, if the timing N is included in a period with “COEFFICIENT×1” in FIG. 10, the coefficient about the consideration-target potential client may be set to 1.

By the process depicted in the flowchart in FIG. 11 like the one described above, a determination result as to whether or not it is appropriate for a sales representative or the like to propose updating (re-delivery) of a product owned by a potential client to the potential client at the timing N is obtained taking into consideration both the perspective as to whether the product is a post-delivery-time-attributed update proposal target and the perspective as to whether the timing N is included in a period during which the potential client is likely to consider updating (re-delivery) of the product.

4-2-1-1-1. Determination about Estimated Update Timing of Owned Product

FIG. 12 depicts a flowchart inside Step 1101 (estimated update timing determination step) in FIG. 11.

At Step 1201 in FIG. 12, the sales assistance system 200 (the estimated update timing determining section, which is one of functional sections included in the priority potential client determining section) assesses whether or not the estimated update timing information 343 about the product owned by the consideration-target potential client has already been recorded in the client information data 301 in the sales record database 231. If an assessment result of Step 1201 is YES, determination about an estimated update timing according to the flowchart in FIG. 12 is not performed again. If an assessment result of Step 1201 is NO, the control proceeds to Step 1202. Note that, even if an assessment result of Step 1201 is YES, Step 1202 and processes thereafter may be executed provided that the estimated update timing (information) 343 is to be determined again for some reason.

At Step 1202 in FIG. 12, the sales assistance system 200 (estimated update timing determining section) reads out the delivery timing information 342 about the product owned by the consideration-target potential client from the client information data 301 in the sales record database 231.

At Step 1203 in FIG. 12, the sales assistance system 200 (estimated update timing determining section) reads out the recommended update time information 411 about the model number of the product owned by the consideration-target potential client from the product specification data 401 in the product information database 232.

At Step 1204 in FIG. 12, the sales assistance system 200 (estimated update timing determining section) reads out the installation location environment information 431 about the product owned by the consideration-target potential client from the client-owned-product data 402 in the product information database 232. For example, the installation location environment information 431 may be information about the temperature of a location where the product is installed or information about the dust volume of the location. Note that, instead of the installation location environment information 431 or in addition to the installation location environment information 431, the sales assistance system 200 (estimated update timing determining section) may read out information that is recorded in the client information data 301 in the sales record database 231 and represents the environmental status of the location where the product is installed. For example, such information representing the environmental status may be information that a sales representative or the like has recorded in the note information 337 or the sales record information 352 in advance through sales activities.

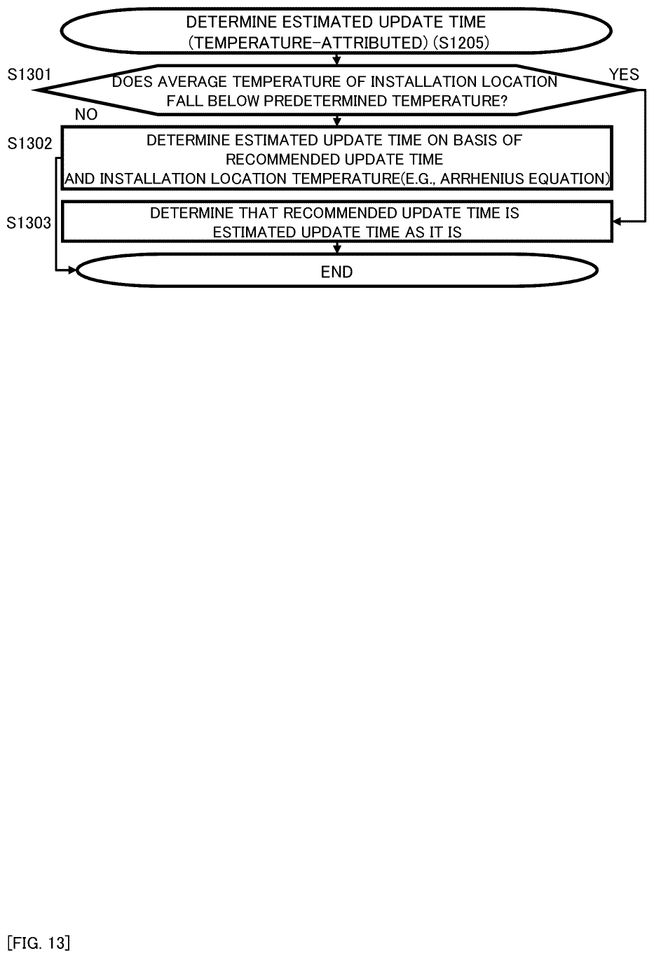

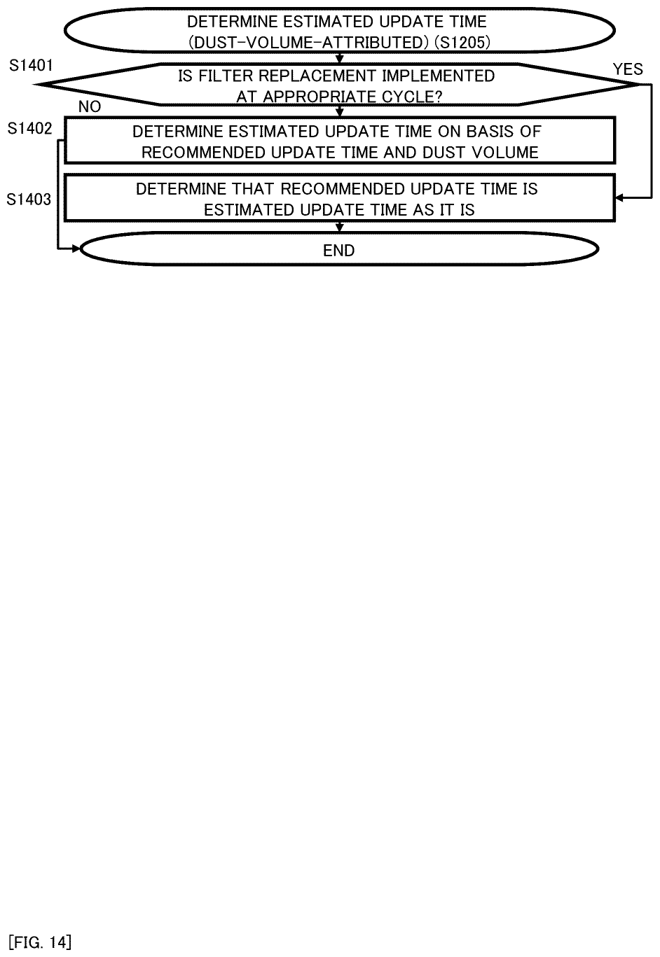

At Step 1205 (estimated update time determination step) in FIG. 12, the sales assistance system 200 (an estimated update time determining section, which is one of functional sections included in the estimated update timing determining section) determines estimated update time 1043 on the basis of the recommended update time information 411 and the installation location environment information 431 (or information that is recorded in the note information 337 or the sales record information 352 and represents the environmental status of the location where the product is installed). The estimated update time 1043 is time between a timing when the product owned by the consideration-target potential client has been delivered and an estimated timing when the product is to be updated (re-delivered). As necessary, the estimated update time 1043 is adjusted (shortened) on the basis of the installation location environment information 431 (or information that is recorded in the note information 337 or the sales record information 352 and represents the environmental status of the location where the product is installed). Two examples of Step 1205 are explained later using FIG. 13 and FIG. 14.

At Step 1206 (estimated update timing calculation step) in FIG. 12, the sales assistance system 200 (an estimated update timing calculating section, which is one of functional sections included in the estimated update timing determining section) calculates the estimated update timing (information) 343 on the basis of the delivery timing information 342 and the estimated update time 1043. For example, the sales assistance system 200 (estimated update timing calculating section) may calculate, as the estimated update timing (information) 343, a timing at which the estimated update time 1043 has elapsed from the delivery timing (information) 342. For example, if the delivery timing (information) 342 is Aug. 17, 2023 and the estimated update time 1043 is eight years and four months, Dec. 17, 2031 (or December 2031) may be calculated as the estimated update timing (information) 343.

By determining the estimated update time 1043 and calculating the estimated update timing (information) 343 at Steps 1205 and 1206 described above, an update timing of the product is estimated taking into consideration variations (fluctuations) of the lifetime of the product according to the status of the location where the product is installed.

At Step 1207 in FIG. 12, the sales assistance system 200 (estimated update timing determining section) records the estimated update timing information 343 in the client information data 301 in the sales record database 231.

### 4-2-1-1-1-1. Estimated-Update-Time Determination (Temperature-Attributed)

FIG. 13 depicts a flowchart inside Step 1205 in an example in which information representing the status of the temperature of the location where the product owned by the consideration-target potential client is installed is used at Step 1205 (estimated update time determination step) in FIG. 12.

At Step 1301 in FIG. 13, the sales assistance system 200 (estimated update time determining section) may assess whether or not the average temperature (average air temperature) of the location where the product owned by the consideration-target potential client is installed falls below a predetermined temperature, on the basis of the installation location environment information 431 (or information that is recorded in the note information 337 or the sales record information 352 and represents the environmental status of the location where the product is installed). If an assessment result of Step 1301 is YES, the control transitions to Step 1303. If an assessment result of Step 1301 is NO, the control proceeds to Step 1302.

At Step 1302 in FIG. 13, the sales assistance system 200 (estimated update time determining section) may determine (calculate) the estimated update time 1043 of the product owned by the consideration-target potential client on the basis of the recommended update time (information) 411 and the temperature of the location where the product is installed. The determination (calculation) may use the Arrhenius equation.

In a first example in which the Arrhenius equation is used, assuming that the extent of variation within a year of the temperature (air temperature) of the location where the product is installed is “ΔT,” the recommended update time (information) 411 is “L_0,” a predetermined constant is “α,” and the estimated update time 1043 is “L,” the sales assistance system 200 (estimated update time determining section) may determine the estimated update time “L” on the basis of the following formula. (Note that “exp” represents an exponential function using the Napier's constant.)

$$L = L\_ 0 \times \{ 1 - exp ( - α / Δ T ) \}$$

Note that, depending on characteristics of the product, “ΔT” may be the extent of variation within a day of the temperature (air temperature).

In addition, the recommended update time “L_0” may be twice as large as the rated time of the product (e.g., industrial machine). In this case, it is expected that the product is overhauled once from delivery of the product to updating (re-delivery) of the product.

For example, in a case where the product is an industrial machine, it is a common custom to overhaul the product once before the product is updated (a new replacement of the product is bought). Accordingly, by setting the recommended update time “L_0” twice as large as the rated time of the product, an update-time estimation result of the product can be made close to the actual update time. Note that, according to the property of the product, the recommended update time “L_0” of the product may be another integer multiple of the rated time of the product (e.g., once as large as, three times as large as, or four times as large as the rated time of the product).

In a second example in which the Arrhenius equation is used, assuming that a constant is “A,” the activation energy is “E_a,” the gas constant is “R,” the temperature (absolute temperature) is “T,” the lifetime (update time) of the product is “L_*,” and the natural logarithm is “In,” it is premised that the lifetime (update time) “L_*” of the product is expressed by the following formula.

ln(L_*)=A+E_a/(R*T)

Taking the premise mentioned above into consideration, assuming that the activation energy is “E_a,” the gas constant is “R,” the natural logarithm is “ln,” the recommended update time (information) 411 is “L_0,” the temperature (absolute temperature) which is a premise of the recommended update time “L_0” is “T_0,” the temperature (absolute temperature) of the location where the product is installed is “T,” and the estimated update time 1043 is “L,” the sales assistance system 200 (estimated update time determining section) may determine the estimated update time “L” on the basis of the following formula.

ln(L/L_0)=(E_a/R)×(1/T−1/T_0)

This is similar to the first example in which the Arrhenius equation is used in that the recommended update time “L_0” may be twice as large as the rated time of the product (e.g., industrial machine).

At Step 1303 in FIG. 13, the sales assistance system 200 (estimated update time determining section) may use the recommended update time (information) 411 per se as the estimated update time 1043. Alternatively, Step 1302 may be executed always without Step 1301 in FIG. 13.

By the determination (calculation) of the estimated update time 1043 depending on the status of the temperature of the location where the product is installed, like the one depicted in FIG. 13, it is possible to make variations (fluctuations) of the lifetime of the product due to the temperature of the location where the product is installed reflected in update-time estimation of the product.

### 4-2-1-1-1-2. Estimated-Update-Time Determination (Dust-Volume-Attributed)

FIG. 14 depicts a flowchart inside Step 1205 in an example in which information representing the status of the dust volume of the location where the product owned by the consideration-target potential client is installed is used at Step 1205 (estimated update time determination step) in FIG. 12.

At Step 1401 in FIG. 14, the sales assistance system 200 (estimated update time determining section) assesses whether or not a dust filter for making dust unlikely to be taken into the product (e.g., air compressor) owned by the consideration-target potential client has been replaced at appropriate time intervals (cycle). In order to assess the actual situation of replacement of the dust filter, the installation location environment information 431 (or information that is recorded in the note information 337 or the sales record information 352 and represents the environmental status of the location where the product is installed) may be used. Alternatively, in order to assess the actual situation of replacement of the dust filter, the maintenance status information 432 of each product recorded in the client-owned-product data 402 in the product information database 232 (or information that is recorded in the note information 337 or the sales record information 352 and represents the maintenance status of the product) may be used. If an assessment result of Step 1401 is YES, the control proceeds to Step 1403. If an assessment result of Step 1401 is NO, the control proceeds to Step 1402.

At Step 1402 in FIG. 14, the sales assistance system 200 (estimated update time determining section) determines (calculates) the estimated update time 1043 on the basis of the recommended update time (information) 411 of the product owned by the consideration-target potential client and information representing the dust volume of the location where the product is installed (e.g., information about the density of dust in the air). As the information representing the dust volume of the location where the product is installed, the installation location environment information 431 (or information that is recorded in the note information 337 or the sales record information 352 and represents the environmental status of the location where the product is installed) may be used. For example, assuming that the recommended update time (information) 411 (or the typical lifetime) is “L_0,” the typical density of dust is “P_0,” the density of dust of the location where the product is installed is “P,” and the estimated update time 1043 is “L,” the sales assistance system 200 (estimated update time determining section) may determine the estimated update time “L” on the basis of the following formula.

$$L = L\_ 0 \times ( P\_ 0 / P )$$

At Step 1403 in FIG. 14, the sales assistance system 200 (estimated update time determining section) may use the recommended update time (information) 411 per se as the estimated update time 1043. Alternatively, Step 1402 may be executed always without Step 1401 in FIG. 14. By the determination (calculation) of the estimated update time 1043 depending on the status of the dust volume (density of dust) of the location where the product is installed, like the one depicted in FIG. 14, it is possible to make variations (fluctuations) of the lifetime of the product due to the dust volume or the density of dust of the location where the product is installed reflected in update-time estimation of the product.

### 4-2-1-1-2. Determination as to Whether or not Owned Product is Post-Delivery-Time-Attributed Update Proposal Target

FIG. 15 depicts a flowchart inside Step 1102 in FIG. 11. As already depicted in the explanation about Step 1102 in FIG. 11, at Step 1102 in FIG. 11, the sales assistance system 200 (priority potential client determining section) determines whether or not the product owned by the potential client is a post-delivery-time-attributed update proposal target.

At Step 1501 in FIG. 15, the sales assistance system 200 (priority potential client determining section) reads out the typical installation time information 412 about the post-updating model number of the product owned by the consideration-target potential client, the model number being available when the product is updated, from the product specification data 401 in the product information database 232.

At Step 1502 (estimated proposal deadline determination step) in FIG. 15, the sales assistance system 200 (an estimated proposal deadline determining section, which is one functional section included in the priority potential client determining section) determines the estimated proposal deadline 1012 for proposing updating (re-delivery) of the product owned by the consideration-target potential client, on the basis of the estimated update timing (information) 343 about the product and the typical installation time (information) 412 of the post-updating model number of the product, the model number being available when the product is updated (and a predetermined time margin in some cases). The sales assistance system 200 (estimated proposal deadline determining section) may determine, as the estimated proposal deadline 1012, a timing which is prior to the estimated update timing (information) 343 by the typical installation time (and the predetermined time margin in some cases). For example, in a case where the estimated update timing (information) 343 is December 2031, the typical installation time (information) 412 is a 12-month period, and the predetermined time margin is a one-month period, the estimated proposal deadline 1012 may be determined as November 2030.

At Step 1504 (part of a post-delivery-time-attributed update proposal target determination step) in FIG. 15, the sales assistance system 200 (a post-delivery-time-attributed update proposal target determining section, which is one functional section included in the priority potential client determining section) assesses whether or not the estimated proposal deadline 1012 comes within the predetermined time 1022 from the timing 160 (timing N) associated with the priority potential client list 170. If an assessment result of Step 1504 is YES, the control proceeds to Step 1506. If an assessment result of Step 1504 is NO, the control proceeds to Step 1507. For example, in a case where the estimated proposal deadline 1012 is November 2030 and the predetermined time 1022 is an 18-month period, an assessment result of Step 1504 may be YES if the timing N is included in the period from May (or June) 2029 to November 2030.

At Step 1506 (part of the post-delivery-time-attributed update proposal target determination step) in FIG. 15, the sales assistance system 200 (post-delivery-time-attributed update proposal target determining section) determines that the product owned by the potential client is a delivery-time-attributed update proposal target. Information (flag) representing this determination result may be recorded in the score information table 601 in the determination database 234. With coordination with a process performed at Step 2113 in FIG. 21 described later, a predetermined score (e.g., 100 points) may be recorded for the item “THERE IS UPDATING TARGET (POST-DELIVERY-TIME-ATTRIBUTED (WITHOUT ENVIRONMENTAL INFLUENCE))” or “THERE IS UPDATING TARGET (POST-DELIVERY-TIME-ATTRIBUTED (WITH ENVIRONMENTAL INFLUENCE))” in the corporation item-by-item score information 621 in the score information table 601, for example.

At Step 1507 (part of the post-delivery-time-attributed update proposal target determination step) in FIG. 15, the sales assistance system 200 (post-delivery-time-attributed update proposal target determining section) determines that the product owned by the potential client is not a delivery-time-attributed update proposal target.

By the process depicted in the flowchart in FIG. 15 described above, an assessment result as to whether or not the timing N is included in a period appropriate for a sales representative or the like to propose, in order to update (complete re-delivery of) the product in the estimated update timing (information) 343 of the product, updating (re-delivery) of the product owned by the potential client to the potential client is obtained.

### 4-2-1-1-3. Estimated Consideration Period Determination

FIG. 20 depicts a flowchart inside Step 1103 (estimated consideration period determination step) in FIG. 11. As depicted in the explanation of Step 1103 in FIG. 11, at Step 1103 in FIG. 11, the sales assistance system 200 (estimated consideration period determining section) determines whether or not the timing N is included in the estimated consideration period 1046, which is an estimated timing when the potential client is likely to consider introduction (delivery) or updating (re-delivery) of the product. Note that the flowchart depicted in FIG. 20 is not only used for Step 1103 in FIG. 11, but also is used for and shared by Step 1103 in FIG. 17 related to consideration of a repair-cost-attributed priority measure and Step 1103 in FIG. 19 related to consideration of a priority measure attributable to another factor.

Steps 2001 to 2003 in FIG. 20 determine the estimated consideration period 1046 of the consideration-target potential client. It is sufficient if these steps are performed once every time the content of information used for determining the estimated consideration period 1046 of the potential client is changed.

At Step 2001 in FIG. 20, the sales assistance system 200 (estimated consideration period determining section) may read out the financial result timing information 526 about the consideration-target potential client from the corporation data 501 in the corporation database 233.

At Step 2002 in FIG. 20, the sales assistance system 200 (estimated consideration period determining section) may estimate the budget formulation timing 1036 on the basis of the financial result timing (information) 526. For example, the sales assistance system 200 (estimated consideration period determining section) may estimate that the budget formulation timing 1036 is a timing which is six months before the financial result timing (information) 526. For example, if the financial result timing of a certain potential client is March every year, the budget formulation timing of the certain potential client may be estimated as September every year.

At Step 2003 in FIG. 20, the sales assistance system 200 (estimated consideration period determining section) may estimate the estimated consideration period 1046 which is an estimated period during which the consideration-target potential client is likely to consider introduction (delivery) or updating (re-delivery) of the product, on the basis of the financial result timing (information) 526 or the budget formulation timing 1036 of the potential client. For example, the sales assistance system 200 (estimated consideration period determining section) may estimate that the estimated consideration period 1046 is a period which is five to three months before the budget formulation timing 1036. For example, if an estimated budget formulation timing of a certain potential client is September every year, the estimated consideration period 1046 of the certain potential client may be April to June every year.

By the process represented by Step 2003 described above, it is possible to set the estimated consideration period 1046 by using the financial result timing (information) 526, which is information published about the potential client. That is, it becomes possible to set the estimated consideration period 1046 even in a situation where information about the internal circumstance of the potential client cannot be obtained. Note that, if a sales representative or the like has obtained, through sales activities or the like, information about a timing when the potential client is likely to consider introduction (delivery) or updating (re-delivery) of the product, Step 2003 described above may be bypassed, and the estimated consideration period 1046 may be set on the basis of the obtained information.

At Step 2004 in FIG. 20, the sales assistance system 200 (estimated consideration period determining section) assesses whether or not the timing 160 (timing N) associated with the priority potential client list 170 is included in the estimated consideration period 1046 of the consideration-target potential client. If an assessment result of Step 2004 is YES, the control transitions to Step 2005. If an assessment result of Step 2004 is NO, the control transitions to Step 2006. For example, in a case where the estimated consideration period 1046 of the consideration-target potential client is April to June every year, an assessment result of Step 2004 is YES if the timing N is June 2029; on the other hand, an assessment result of Step 2004 is NO if the timing N is August 2030.

At Step 2005 in FIG. 20, the sales assistance system 200 (estimated consideration period determining section) determines that the timing N is included in the estimated consideration period of the consideration-target potential client.

At Step 2006 in FIG. 20, the sales assistance system 200 (estimated consideration period determining section) determines that the timing N is not included in the estimated consideration period of the consideration-target potential client.

### 4-2-1-2. Repair-Cost-Attributed Priority Measure

FIG. 16 depicts various types of timings, various types of periods, and various types of time handled in a repair-cost-attributed priority measure consideration process performed at Step 902 in FIG. 9, and also depicts a mode of score addition to a pre-correction score and a mode of coefficient setting as a repair-cost-attributed priority measure.

FIG. 17 depicts a flowchart of the repair-cost-attributed priority measure consideration process performed at Step 902 in FIG. 9. The flowchart in FIG. 17 is explained with reference to FIG. 16.

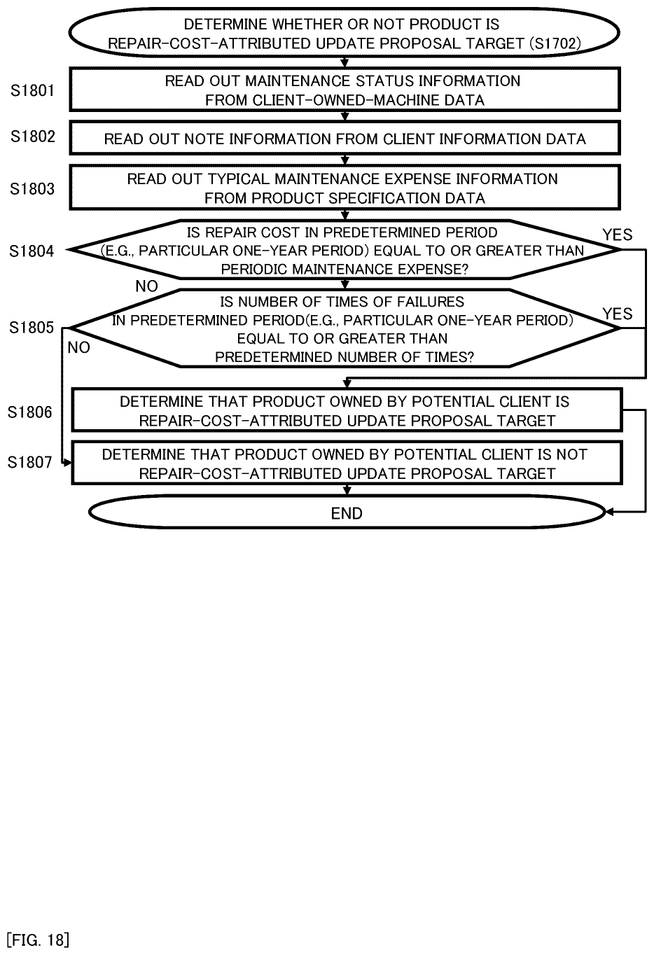

At Step 1702 in FIG. 17, the sales assistance system 200 (priority potential client determining section) determines whether or not the product owned by the consideration-target potential client is a repair-cost-attributed update proposal target. Unlike the post-delivery-time-attributed update proposal explained using FIG. 10 and FIG. 11, the product owned by the consideration-target potential client becomes a repair-cost-attributed update proposal target immediately if the product satisfies a repair-cost-attributed condition (e.g., a repair-cost-attributed condition depicted in FIG. 18). Accordingly, as depicted in FIG. 16, at and after “TIMING WHEN PRODUCT HAS BECOME REPAIR-COST-ATTRIBUTED UPDATE PROPOSAL TARGET,” the product owned by the consideration-target potential client is always a repair-cost-attributed update proposal target (until a sales representative or the like actually proposes updating (re-delivery) of the product to the potential client). Details of Step 1702 are explained later using FIG. 18.

At Step 1103 (estimated consideration time determination step) in FIG. 17, the sales assistance system 200 (the estimated consideration time determining section, which is one functional section included in the priority potential client determining section) determines whether or not the timing N is included in the estimated consideration period 1046, which is an estimated timing when the potential client is likely to consider introduction (delivery) or updating (re-delivery) of the product. The mutual relation between the financial result timing (information) 526, the budget formulation timing 1036, and the estimated consideration period 1046 of the potential client is similar to that explained with reference to FIG. 10 and FIG. 11, and this is depicted also in FIG. 16. Details of Step 1103 are as already explained using FIG. 20.

At Step 1704 (part of a repair-cost-attributed estimated proposal period determination step) in FIG. 17, the sales assistance system 200 (a repair-cost-attributed estimated proposal period determining section, which is one functional section included in the priority potential client determining section) determines whether or not the timing N is included in a repair-cost-attributed estimated proposal period 1699, which is a period estimated as being suitable for a sales representative or the like to propose updating (re-delivery) of the product which is a repair-cost-attributed update proposal target to the potential client. Regarding the example in FIG. 16, the sales assistance system 200 (repair-cost-attributed estimated proposal period determining section) determines, as the repair-cost-attributed estimated proposal period 1699, a period during which the product owned by the potential client is a repair-cost-attributed update proposal target (in practice, the timing N is included in the period if a repair-cost-attributed condition like the one depicted in FIG. 18 is satisfied) and which is the estimated consideration period 1046. That is, from both the perspective that the product actually satisfies the repair-cost-attributed condition and the perspective that the potential client is likely to make a decision to update (request re-delivery of) the product, the repair-cost-attributed estimated proposal period 1699 is suitable as a timing for a sales representative or the like to propose updating (re-delivery) of the product to the potential client. The sales assistance system 200 (repair-cost-attributed estimated proposal period determining section) assesses whether or not the timing N is included in any of the repair-cost-attributed estimated proposal periods 1699. If an assessment result of Step 1704 is YES, the control proceeds to Step 1705. If an assessment result of Step 1704 is NO, the control proceeds to Step 1707.

At Step 1705 (part of the repair-cost-attributed estimated proposal period determination step) in FIG. 17, the sales assistance system 200 (repair-cost-attributed estimated proposal period determining section) determines that the timing N corresponding to the priority potential client list 170 is included in the (repair-cost-attributed) estimated proposal period 1699 of updating (re-delivery) of the product owned by the consideration-target potential client. After Step 1705, the control proceeds to Step 1706.

At Step 1706 (repair-cost-attributed priority measure step) in FIG. 17, the sales assistance system 200 (a repair-cost-attributed priority measure section, which is one functional section included in the priority potential client determining section) takes a repair-cost-attributed priority measure about the consideration-target potential client. For example, the sales assistance system 200 (repair-cost-attributed priority measure section) may set the value of a coefficient which is about the consideration-target potential client and for obtaining a post-correction score from a pre-correction score to 10. That is, if the timing N is included in a period with “COEFFICIENT×10” in FIG. 16, the coefficient about the consideration-target potential client may be set to 10.

At Step 1707 (part of the repair-cost-attributed estimated proposal period determination step) in FIG. 17, the sales assistance system 200 (repair-cost-attributed estimated proposal period determining section) determines that the timing N corresponding to the priority potential client list 170 is not included in the (repair-cost-attributed) estimated proposal period 1699 of updating (re-delivery) of the product owned by the consideration-target potential client. In this case, for example, the value of a coefficient which is about the consideration-target potential client and for obtaining a post-correction score from a pre-correction score may be set to 1. That is, if the timing N is included in a period with “COEFFICIENT×1” in FIG. 16, the coefficient about the consideration-target potential client may be set to 1.

By the process depicted in the flowchart in FIG. 17 described above, it is assessed whether or not the timing N is a timing suitable for a sales representative or the like to propose updating (re-delivery) of the product owned by the potential client to the potential client, from both the perspective as to whether or not the product is a repair-cost-attributed update proposal target and the perspective as to whether or not the timing N is included in a period during which the potential client is likely to consider updating (re-delivery) of the product. In addition, it is also possible to make it likely for the consideration-target potential client to be determined as a priority potential client of the timing N depending on a result of the assessment.

### 4-2-1-2-1. Determination as to Whether or not Owned Product is Repair-Cost-Attributed Update Proposal Target

FIG. 18 depicts a flowchart inside Step 1702 in FIG. 17. As already depicted in the explanation about Step 1702 in FIG. 17, at Step 1702 in FIG. 17, the sales assistance system 200 (priority potential client determining section) determines whether or not the product owned by the potential client is a repair-cost-attributed update proposal target.

At Step 1801 in FIG. 18, the sales assistance system 200 (priority potential client determining section) may read out the maintenance status information 432 about the product owned by the consideration-target potential client from the client-owned-product data 402 in the product information database 232.

At Step 1802 in FIG. 18, the sales assistance system 200 (priority potential client determining section) may read out the note information 337 about the consideration-target potential client from the client information data 301 in the sales record database 231. Instead of this or in addition to this, the sales assistance system 200 (priority potential client determining section) may read out the sales record information 352 about the consideration-target potential client from the client information data 301 in the sales record database 231. Information about the maintenance status of the product owned by the consideration-target potential client in the note information 337 or the sales record information 352 can be used at the following steps.

In addition, only one of Step 1801 and Step 1802 may be executed.

At Step 1803 in FIG. 18, the sales assistance system 200 (priority potential client determining section) may read out the typical maintenance expense information 415 about the product owned by the consideration-target potential client from the product specification data 401 in the product information database 232. The typical maintenance expense information 415 may represent typical expenses required for periodic maintenance.

At Step 1804 (part of a repair-cost-attributed update proposal target determination step) in FIG. 18, about the product owned by the consideration-target potential client, the sales assistance system 200 (a repair-cost-attributed update proposal target determining section, which is one functional section included in the priority potential client determining section) may compare expenses (repair costs) required for repairs in a predetermined period (e.g., a particular one-year period) and typical expenses required for periodic maintenance in the predetermined period. Alternatively, about the product owned by the consideration-target potential client, the sales assistance system 200 (repair-cost-attributed update proposal target determining section) may compare expenses (repair costs) required for repairs in a predetermined period (e.g., a particular one-year period) and expenses actually required for periodic maintenance in the predetermined period. If, as a result of the assessment at Step 1804, the repair costs are equal to or greater than the expenses for the periodic maintenance, which is a comparison target, or exceeds the expenses for the periodic maintenance, which is a comparison target, the control proceeds to Step 1806. Otherwise, the control proceeds to Step 1805.

At Step 1805 (part of the repair-cost-attributed update proposal target determination step) in FIG. 18, about the product owned by the consideration-target potential client, the sales assistance system 200 (repair-cost-attributed update proposal target determining section) assesses whether or not the number of times of failures (repairs) (the number of times of failures) in a predetermined period (e.g., a particular one-year period) is equal to or greater than a predetermined number of times (e.g., three times). If an assessment result of Step 1805 is YES, the control proceeds to Step 1806. If an assessment result of Step 1805 is NO, the control proceeds to Step 1807.

At Step 1806 (part of the repair-cost-attributed update proposal target determination step) in FIG. 18, the sales assistance system 200 (repair-cost-attributed update proposal target determining section) determines that the product owned by the potential client is a repair-cost-attributed update proposal target. At this time, information (flag) representing that this determination has been performed may be recorded in the score information table 601 in the determination database 234. With coordination with a process performed at Step 2113 in FIG. 21 described later, a predetermined score (e.g., 100 points) may be recorded for the item “THERE IS UPDATING TARGET (REPAIR-COST-ATTRIBUTED)” in the corporation item-by-item score information 621 in the score information table 601, for example.

At Step 1807 (part of the repair-cost-attributed update proposal target determination step) in FIG. 18, the sales assistance system 200 (repair-cost-attributed update proposal target determining section) determines that the product owned by the potential client is not a repair-cost-attributed update proposal target.

By the process depicted in the flowchart in FIG. 18 described above, about the product owned by the potential client, it is possible to rightly sense a situation where it is more reasonable to perform updating (re-delivery) of the product than to perform maintenance inspections or repairs as appropriate while putting off updating (re-delivery).

### 4-2-1-3. Priority Measure Attributable to Another Factor

FIG. 19 depicts a flowchart of a process of considering a priority measure attributable to another factor which is a factor other than post-delivery time or repair cost, the process being performed at Step 903 in FIG. 9.

At Step 1902 in FIG. 19, the sales assistance system 200 (priority potential client determining section) determines whether or not a potential client itself or products owned by the potential client is a proposal target of introduction (delivery) or updating (re-delivery) of some product for a reason attributable to another factor which is a factor other than post-delivery time or repair cost. For example, the sales assistance system 200 (priority potential client determining section) may determine that a new client (candidate) is a proposal target of introduction (delivery) or updating (re-delivery) of some product, in a case where a pre-correction score (described later) of the new client (candidate) is equal to or greater than a threshold.

At Step 1103 (estimated consideration time determination step) in FIG. 19, the sales assistance system 200 (the estimated consideration time determining section, which is one functional section included in the priority potential client determining section) determines whether or not the timing N is included in the estimated consideration period 1046, which is an estimated timing when the potential client is likely to consider introduction (delivery) or updating (re-delivery) of the product. Details of Step 1103 are as already explained using FIG. 20.

At Step 1904 in FIG. 19, about the certain potential client or the product which is an update proposal target attributable to another factor, the sales assistance system 200 (priority potential client determining section) determines whether or not the timing N is included in an estimated proposal period which is a period estimated as being suitable for a sales representative or the like to propose introduction (delivery) or updating (re-delivery) of the product to the potential client. For example, the sales assistance system 200 (priority potential client determining section) determines that the estimated consideration period 1046 is an estimated proposal period attributable to another factor as it is, if the pre-correction score of the new client (candidate) is equal to or greater than the threshold. That is, from both the perspective that it is suitable to propose introduction (delivery) or updating (re-delivery) of the product for some factor represented by the pre-correction score and the perspective that the potential client is likely to make a decision about introduction (delivery) or updating (re-delivery) of the product, the estimated proposal period attributable to another factor is suitable as a timing for a sales representative or the like to propose introduction (delivery) or updating (re-delivery) of the product to the potential client. The sales assistance system 200 (priority potential client determining section) assesses whether or not the timing N is included in any of the estimated proposal periods attributable to another factor. If an assessment result of Step 1904 is YES, the control proceeds to Step 1905. If an assessment result of Step 1904 is NO, the control proceeds to Step 1907.

At Step 1905 in FIG. 19, the sales assistance system 200 (priority potential client determining section) determines that the timing N corresponding to the priority potential client list 170 is included in the estimated proposal period (attributable to another factor) about the consideration-target potential client. After Step 1905, the control proceeds to Step 1906.

At Step 1906 in FIG. 19, the sales assistance system 200 (priority potential client determining section) takes a priority measure attributable to another factor, about the consideration-target potential client. For example, the sales assistance system 200 (priority potential client determining section) may set the value of a coefficient which is about the consideration-target potential client and for obtaining a post-correction score from a pre-correction score to 10.

At Step 1907 in FIG. 19, the sales assistance system 200 (priority potential client determining section) determines that the timing N corresponding to the priority potential client list 170 is not included in the estimated proposal period (attributable to another factor) about the consideration-target potential client. In this case, for example, the value of a coefficient that is about the consideration-target potential client and for obtaining a post-correction score from a pre-correction score may be set to 1.

### 4-2-2. Pre-Correction Score Calculation

As depicted in the explanation of Step 803 (pre-correction score calculation step) in FIG. 8, the sales assistance system 200 (the pre-correction score calculating section as one functional section included in the priority potential client determining section) calculates a pre-correction score of the potential client selected at Step 801 (consideration-target potential client). Hereinbelow, an approach to calculating the pre-correction score in a case where the consideration-target potential client is an existing client is explained using a flowchart depicted in FIG. 21 and FIG. 23. In addition, an approach to calculating the pre-correction score in a case where the consideration-target potential client is a new client (candidate) is explained using a flowchart depicted in FIG. 22 and FIG. 23 and FIG. 24. (Note that the item “LAUNCH OF NEW VERSION OF SOFTWARE USED FOR PRODUCT” depicted in FIG. 23 is explained separately in a modification example (ε) described later, because the explanation becomes complicated if given here.)

FIG. 23 depicts part of the score definition information 602 recorded in the determination database 234, corporation item-by-item score information 2301 (621, 631) that is recorded in the score information table 601 in the determination database 234 and is about existing-client Corporation A, existing-client Corporation B, existing-client Corporation C, and new-client (candidate) Corporation Y, and corporation pre-correction score information 2303 (623, 633) that is recorded in the score information table 601 in the determination database 234 and is about existing-client Corporation A, existing-client Corporation B, existing-client Corporation C, and new-client (candidate) Corporation Y.

FIG. 24 depicts part of the score definition information 602 recorded in the determination database 234, individual item-by-item score information 2401 (641, 651, 661) that is recorded in the score information table 601 in the determination database 234 and is about Individual y1 belonging to new-client (candidate) Corporation Y, Individual y2 belonging to Corporation Y, and new-client (candidate) Individual z, and individual pre-correction score information 2403 (643, 653, 663) that is recorded in the score information table 601 in the determination database 234 and is about Individual y1 belonging to new-client (candidate) Corporation Y, Individual y2 belonging to Corporation Y, and new-client (candidate) Individual z.

What is depicted in the column “ITEM” and the column “ADDED SCORE” in information depicted in FIG. 23 and FIG. 24 is included in the score definition information 602. Note that rates of increase, increasing (rising), and decreasing (lowering) that are described in “ITEM” in FIG. 23 may mean rates of increase, increasing (rising), and decreasing (lowering) of the current (latest) fiscal year as compared to the previous fiscal year.

An administrator of the sales assistance system 200 or a sales representative or the like may input in advance, as the score definition information 602 and to the sales assistance system 200, how many scores are added as item-by-item scores when which conditions are satisfied by a potential client (corporation or individual) or an individual belonging to a potential client (corporation). In addition, the administrator of the sales assistance system 200 or the sales representative or the like may instruct the sales assistance system 200 to change the score definition information 602 having already been set.

### 4-2-2-1. Pre-Correction Score Calculation (Existing Client)

FIG. 21 depicts a flowchart executed in a case where the consideration-target potential client is an existing client already owning a product, at Step 803 (pre-correction score calculation step) in FIG. 8. Each of steps in FIG. 21 may be executed by the pre-correction score calculating section, which is one functional section included in the priority potential client determining section, which is a functional section of the sales assistance system 200. Note that a pre-correction score may be calculated even for a new client (candidate) by performing a process depicted in the flowchart in FIG. 21, if the new client (candidate) owns a product and the sales assistance system 200 can acquire information about the product. In addition, whereas it is premised in the following explanation using FIG. 21 that a consideration-target existing client is a corporation, a pre-correction score may be calculated even for an individual who is an existing client, by performing the process depicted in the flowchart in FIG. 21, if the individual owns a product.

At Step 2101 in FIG. 21, the sales assistance system 200 (pre-correction score calculating section) may read out the score definition information 602 from the determination database 234.

At Step 2105 in FIG. 21, the sales assistance system 200 (pre-correction score calculating section) may read out corporation information (511, 512, 513, and 514 in FIG. 5) about the consideration-target potential client from the corporation data 501 in the corporation database 233.

At Step 2106 in FIG. 21, the sales assistance system 200 (pre-correction score calculating section) may read out business category information about a business category to which the consideration-target potential client belongs, from the business category data 502 in the corporation database 233.

At Step 2107 in FIG. 21, the sales assistance system 200 (pre-correction score calculating section) may read out macroeconomic information about a country or a region to which the consideration-target potential client belongs, from the macroeconomic data 503 in the corporation database 233.

At Step 2108 in FIG. 21, the sales assistance system 200 (pre-correction score calculating section) records item-by-item score information for the consideration-target potential client in the score information table 601, on the basis of some or all of the corporation information, the business category information, and the macroeconomic information as well as the score definition information 602. For example, if the consideration-target potential client is an existing client and a corporation, the corporation item-by-item score information 2301 (621 in FIG. 6) of the potential client may be recorded. (Note that, if the consideration-target potential client is an existing client and an individual (not belonging to a corporation), individual item-by-item score information about the potential client may be recorded.) The sales assistance system 200 (pre-correction score calculating section) may refer to items (those for which conditions for score addition are written) included in the score definition information 602, and assess whether or not the consideration-target potential client satisfies the conditions represented by the items, on the basis of the corporation information, the business category information, and the macroeconomic information. In a case where a condition represented by a certain item is satisfied, the sales assistance system 200 (pre-correction score calculating section) may apply, to the consideration-target potential client, score addition set for the certain item, and make the score addition reflected by the item-by-item score information. Regarding the example in FIG. 23, in a case where it is known that, on the basis of the performance information in the Corporation-B corporation information 512 about existing-client Corporation B, the rate of increase of the sales of the current fiscal year of Corporation B from the previous fiscal year is equal to or greater than 10 percent and lower than 20 percent, the sales assistance system 200 (pre-correction score calculating section) may record “10 points” for the item “HIGHLY GROWING (RATE OF INCREASE OF SALES=10% OR HIGHER)” in the corporation item-by-item score information in the Corporation-B score information 612.

At Step 2109 in FIG. 21, the sales assistance system 200 (pre-correction score calculating section) reads out the delivery timing information 342 about products owned by the consideration-target potential client from the client information data 301 in the sales record database 231.

At Step 2110 in FIG. 21, the sales assistance system 200 (pre-correction score calculating section) assesses whether or not the elapsed time between the timings of introduction (delivery) or the timings of updating (re-delivery) of all of the products owned by the consideration-target potential client and the timing N is shorter than predetermined time (e.g., a one-year period). If an assessment result of Step 2110 is YES, the control proceeds to Step 2111. If an assessment result of Step 2110 is NO, the control proceeds to Step 2112.

At Step 2111 in FIG. 21, the sales assistance system 200 (pre-correction score calculating section) may record a predetermined score (e.g., “−5 points”) for the item “CORPORATION FOR WHICH MORE THAN ONE YEAR HAS NOT ELAPSED FROM DELIVERY (UPDATING) OF TARGET PRODUCT” in the corporation item-by-item score information 2301 about the consideration-target potential client in the score information table 601 in the determination database 234. That is, (item-by-item scores to be the grounds for calculation of) pre-correction scores of potential clients may be set such that the priority of sales activities for a potential client having only products whose elapsed time from introduction (delivery) or updating (re-delivery) is relatively short is lowered.

At Step 2112 in FIG. 21, the sales assistance system 200 (pre-correction score calculating section) assesses whether a product owned by the consideration-target potential client is a “post-delivery-time-attributed update proposal target” as assessed in FIG. 15 or a “repair-cost-attributed update proposal target” as assessed in FIG. 18. This assessment may be performed for each product owned by the potential client. In a case where a result of the assessment about any of products at Step 2112 is YES, the control proceeds to Step 2113. Otherwise, the control proceeds to Step 2114.

At Step 2113 in FIG. 21, the sales assistance system 200 (pre-correction score calculating section) records a predetermined score for the item “THERE IS UPDATING TARGET (POST-DELIVERY-TIME-ATTRIBUTED (WITHOUT ENVIRONMENTAL INFLUENCE)),” “THERE IS UPDATING TARGET (POST-DELIVERY-TIME-ATTRIBUTED (WITH ENVIRONMENTAL INFLUENCE)),” or “THERE IS UPDATING TARGET (REPAIR-COST-ATTRIBUTED)” in the corporation item-by-item score information 2301 about the consideration-target potential client in the score information table 601 in the determination database 234. About each of the products owned by the consideration-target potential client, the sales assistance system 200 (pre-correction score calculating section) may add a predetermined score (e.g., “100 points”) to the record if the product is a “post-delivery-time-attributed update proposal target” as assessed in FIG. 15 or a “repair-cost-attributed update proposal target” as assessed in FIG. 18. In the example in FIG. 23, taking into consideration the fact that Corporation A is a “post-delivery-time-attributed update proposal target” and has three products whose recommended update time (information) 411 is determined at Step 1205 in FIG. 12 as the estimated update time 1043 as it is (determined as not to be shortened because of their installation location environments), “300 points” is recorded for the item “THERE IS UPDATING TARGET (POST-DELIVERY-TIME-ATTRIBUTED (WITHOUT ENVIRONMENTAL INFLUENCE))” about Corporation A. In addition, taking into consideration the fact that the Corporation B is a “post-delivery-time-attributed update proposal target” and has one product whose estimated update time 1043 is shortened as compared to the recommended update time (information) 411 at Step 1205 in FIG. 12 (determined to be shortened because of its installation location environment), “100 points” is recorded for the item “THERE IS UPDATING TARGET (POST-DELIVERY-TIME-ATTRIBUTED (WITH ENVIRONMENTAL INFLUENCE))” about Corporation B. Further, taking into consideration the fact that Corporation C has one product determined as a “repair-cost-attributed update proposal target,” “100 points” is recorded for the item “THERE IS UPDATING TARGET (REPAIR-COST-ATTRIBUTED)” about Corporation C. (Note that, in FIG. 23, because Corporation Y is a new client (candidate) and the sales assistance system 200 cannot acquire information about the product owned by Corporation Y, scores are not recorded for the items “THERE IS UPDATING TARGET (POST-DELIVERY-TIME-ATTRIBUTED (WITHOUT ENVIRONMENTAL INFLUENCE)),” “THERE IS UPDATING TARGET (POST-DELIVERY-TIME-ATTRIBUTED (WITH ENVIRONMENTAL INFLUENCE)),” and “THERE IS UPDATING TARGET (REPAIR-COST-ATTRIBUTED)” about Corporation Y.)

By the process represented by Steps 2112 and 2113 described above, in a case where a product owned by a potential client is a post-delivery-time-attributed update proposal target or a repair-cost-attributed update proposal target at the time N (regardless of whether or not the time N is included in the estimated consideration period 1046 of the potential client), a relatively large score can be given as the pre-correction score of the potential client. That is, even if the timing N is a timing not included in the estimated consideration period 1046 of the potential client, the pre-correction score of the potential client owning a product that has become an update proposal target for some factor can be set higher. It can be said that, in a case where a sales representative or the like has energy enough to spare for sales activities, factors for assessment for performing such sales activities for the potential client can be provided to the sales representative or the like.

After Step 2113, the control proceeds to Step 2114.

At Step 2114 in FIG. 21, the sales assistance system 200 (pre-correction score calculating section) determines highly scored items among scores recorded for items included in the corporation item-by-item score information 2301 about the consideration-target potential client. The sales assistance system 200 (pre-correction score calculating section) may determine, as “highly scored items,” items for which the highest scores are given, or may determine, as “highly scored items,” one or more items for which scores equal to or larger than a predetermined threshold are given or scores exceeding the predetermined threshold are given. The sales assistance system 200 (pre-correction score calculating section) may record the names or the like of “highly scored items” in the corporation needs detail information (622, 632 in FIG. 6) about the consideration-target potential client in the score information table 601 in the determination database 234. The sales assistance system 200 (pre-correction score calculating section) may record, in the corporation needs detail information, the names represented by the fields of “ITEM” in FIG. 23 (or FIG. 24) as they are. Alternatively, instead of recording the names represented by the fields of “ITEM” in FIG. 23 (or FIG. 24) as they are, the sales assistance system 200 (pre-correction score calculating section) may replace the names with terms or the like that can easily be understood by a sales representative or the like, and record the terms of the like in the corporation needs detail information. For example, such terms as “update timing,” “high-temperature, high-pressure environment (or excessive amount of dust),” or “repair cost” may replace the names of the items “THERE IS UPDATING TARGET (POST-DELIVERY-TIME-ATTRIBUTED (WITHOUT ENVIRONMENTAL INFLUENCE),” “THERE IS UPDATING TARGET (POST-DELIVERY-TIME-ATTRIBUTED (WITH ENVIRONMENTAL INFLUENCE)),” and “THERE IS UPDATING TARGET (REPAIR-COST-ATTRIBUTED)” and be recorded in the corporation needs detail information.

At Step 2118 in FIG. 21, the sales assistance system 200 (pre-correction score calculating section) calculates the sum total of the corporation item-by-item scores about the consideration-target potential client, and records the sum total as corporation pre-correction score information (623, 633 in FIG. 6) in the score information table 601 in the determination database 234. In the example in FIG. 23, regarding Corporation A, “5 points” is recorded for the item “ACTIVELY PROMOTING CAPITAL INVESTMENT,” “5 points” is recorded for the item “MACROECONOMIC INDICATORS ARE GOOD,” and “300 points” is recorded for the item “THERE IS UPDATING TARGET (POST-DELIVERY-TIME-ATTRIBUTED (WITHOUT ENVIRONMENTAL INFLUENCE)).” Accordingly, “SUM TOTAL OF CORPORATION ITEM-BY-ITEM SCORES” is “310 points,” and (if Corporation A is an existing client owning products and individual item-by-item scores are not treated) “SUM TOTAL OF CORPORATION ITEM-BY-ITEM SCORES” is treated as “CORPORATION PRE-CORRECTION SCORE (INFORMATION)” as it is, and “310 points” is recorded.

### 4-2-2-2. Pre-Correction Score Calculation (New Client)

FIG. 22 depicts a flowchart executed in a case where the consideration-target potential client is a new client (candidate), at Step 803 (pre-correction score calculation step) in FIG. 8. Each of steps in FIG. 22 may be executed by the pre-correction score calculating section, which is one functional section included in the priority potential client determining section, which is a functional section of the sales assistance system 200. In FIG. 22, in a case where the new client (candidate) is a corporation and the sales assistance system 200 can acquire web access history information about one or more individuals belonging to the corporation, a pre-correction score is calculated for the corporation and for each of the individuals belonging to the corporation.

At Step 2101 in FIG. 22, the sales assistance system 200 (pre-correction score calculating section) may read out the score definition information 602 from the determination database 234.

At Step 2202 in FIG. 22, the sales assistance system 200 (pre-correction score calculating section) reads out the individual web access history information (361, 371, 372, and 381 in FIG. 3) about the consideration-target potential client from the client information data 301 in the sales record database 231. In a case where the consideration-target potential client is a corporation (in a case of Corporation Y to which Individual y1 and Individual y2 belong in FIG. 3), the individual web access history information about each individual belonging to the corporation is read out. That is, regarding Corporation Y, the Individual-y1 web access history information 371 about Individual y1 and the Individual-y2 web access history information 372 are read out. In a case where the consideration-target potential client is an individual not belonging to a corporation (in a case of Individual z in FIG. 3), the individual web access history information about the individual is read out. That is, the Individual-z web access history information 381 about Individual z is read out.

Note that individual web access history information may be one whose history content is reset (erased) every time a predetermined period (e.g., a three-month period) elapses, or a web access history only of the predetermined most recent period (e.g., a period corresponding to the most recent three-month period) may be treated as an effective history. By limiting web access history information to be treated as effective information to the most recent web access history in this manner, for example, it is possible to realize sales activities in line with the most recent matters of interest or concern of a new-client (candidate) corporation or individual or individuals belonging to a new-client (candidate) corporation.

At Step 2203 in FIG. 22, the sales assistance system 200 (pre-correction score calculating section) determines individual item-by-item scores on the basis of the score definition information 602 and the individual web access history information about the consideration-target potential client, and records the individual item-by-item score information 2401 (641, 651, and 661 in FIG. 6) about the consideration-target potential client in the score information table 601 in the determination database 234. Regarding the example in FIG. 24, if there are browsing records of Individual y1 about access to web product pages of two products at the website of a manufacturer (system user firm) using the sales assistance system 200, “10 points” is recorded for the item “WEB PRODUCT PAGE BROWSING” about Individual y1. (In the example in FIG. 24, in the score definition information 602, it is defined that “+5 points” is added per browsing of a web product page of one product.)

At Step 2204 in FIG. 22, the sales assistance system 200 (pre-correction score calculating section) assesses whether or not the consideration-target individual belongs to a corporation. In a case where an assessment result of Step 2204 is YES (i.e., in a case where the consideration target is a corporation or an individual belonging to a corporation), the control proceeds to Step 2205. In a case where an assessment result of Step 2204 is NO (i.e., in a case where the consideration target is an individual not belonging to a corporation), (Steps 2205 to 2214 are skipped, and) the control proceeds to Step 2215.

Since Steps 2205, 2206, 2207, 2208, and 2214 in FIG. 22 have the content of processes similar to the content of the processes performed at Steps 2105, 2106, 2107, 2108, and 2114 in FIG. 21, respectively, explanations about details of the processes are omitted. It should be noted that there is a difference in that, while an individual belonging to a corporation is not handled in a case where the consideration target is a (existing-client) corporation in the flowchart in FIG. 21, the consideration targets are a (new-client (candidate)) corporation and an individual belonging to the corporation in Steps 2205, 2206, 2207, 2208, and 2214 in the flowchart in FIG. 22. In addition, (unlike Step 2114 in FIG. 21) at Step 2214 in FIG. 22, in recording the corporation needs detail information, the sales assistance system 200 (pre-correction score calculating section) may determine a highly scored item from among the items including both items for the corporation item-by-item scores and items for the individual item-by-item scores (about each of individuals belonging to the corporation), and record the highly scored item (which may be an item for an individual item-by-item score) in the corporation needs detail information.

At Step 2215 in FIG. 22, (in a case where the control proceeds to Step 2215 from Step 2214) the sales assistance system 200 (pre-correction score calculating section) may determine a highly scored item from among the items including both items for the corporation item-by-item scores (of the corporation to which the individuals belong) and items for the individual item-by-item scores (of the individuals), and record, in the individual needs detail information, the highly scored item (which may either be an item for the corporation item-by-item scores or an item for the individual item-by-item scores).

The relation between Step 2214 and Step 2215 is explained. For example, in a case where a highly scored item in the corporation item-by-item scores of Corporation Y is “VERY HIGHLY GROWING,” highly scored items in the individual item-by-item scores of Individual y1 are “TECHNICAL DOCUMENT DOWNLOAD” and “CATALOGUE DOWNLOAD,” and there are no highly scored items in the individual item-by-item scores of Individual y2, “VERY HIGHLY GROWING,” “TECHNICAL DOCUMENT DOWNLOAD,” and “CATALOGUE DOWNLOAD” may be recorded in the corporation needs detail information about Corporation Y and the individual needs detail information about Individual y1; meanwhile, only “VERY HIGHLY GROWING” may be recorded in individual needs detail information about Individual y2.

At Step 2215 in FIG. 22, in a case where the consideration target is an individual not belonging to a corporation, the sales assistance system 200 (pre-correction score calculating section) may determine highly scored items from among items for the individual item-by-item scores of the individual, and record the highly scored items in the individual needs detail information. In the example in FIG. 24, as the individual needs detail information for Individual z, the items “WEB CASE PAGE 2 BROWSING” and “CATALOGUE DOWNLOAD” may be recorded.

At Step 2216 in FIG. 22, the sales assistance system 200 (pre-correction score calculating section) assesses whether or not the consideration-target individual belongs to a corporation. In a case where an assessment result of Step 2216 is YES (i.e., in a case where the consideration target is a corporation or an individual belonging to a corporation), the control proceeds to Step 2217. In a case where an assessment result of Step 2204 is NO (i.e., in a case where the consideration target is an individual not belonging to a corporation), the control proceeds to Step 2219.

At Step 2217 in FIG. 22, about each of individuals belong to the corporation which is the consideration-target potential client, the sales assistance system 200 (pre-correction score calculating section) calculates the sum total of the individual item-by-item scores and the corporation item-by-item scores of the corporation to which the individual belong. Then, the sales assistance system 200 (pre-correction score calculating section) determines the sum total as an individual pre-correction score of the individual, and records individual pre-correction score information (643 and 653 in FIG. 6) in the score information table 601 in the determination database 234. For example, regarding the examples in FIG. 23 and FIG. 24, since the sum total of corporation item-by-item scores of Corporation Y is “55 points” and the sum total of the individual item-by-item scores of Individual y1 is “110 points,” the individual pre-correction score of Individual y1 is “165 points.” Similarly, since the sum total of corporation item-by-item scores of Corporation Y is “55 points” and the sum total of individual item-by-item scores of Individual y2 is “12 points,” the individual pre-correction score of Individual y2 is “67 points.”

At Step 2218 in FIG. 22, about the corporation which is the consideration-target potential client, the sales assistance system 200 (pre-correction score calculating section) calculates the sum total of the individual item-by-item scores of the respective individuals belonging to the corporation and the corporation item-by-item scores of the corporation. Then, the sales assistance system 200 (pre-correction score calculating section) determines the sum total as a corporation pre-correction score of the corporation, and records corporation pre-correction score information (633 in FIG. 6) in the score information table 601 in the determination database 234. For example, regarding the examples in FIG. 23 and FIG. 24, since the sum total of corporation item-by-item scores of Corporation Y is “55 points,” the sum total of the individual item-by-item scores of Individual y1 is “110 points,” the sum total of the individual item-by-item scores of Individual y2 is “12 points,” the corporation pre-correction score of Corporation Y is “177 points.”

At Step 2219 in FIG. 22, the sales assistance system 200 (pre-correction score calculating section) calculates the sum total of the individual item-by-item scores of the individual (not belonging to a corporation) who is the consideration-target potential client. Then, the sales assistance system 200 (pre-correction score calculating section) determines the sum total as an individual pre-correction score of the individual, and records individual pre-correction score information (663 in FIG. 6) in the score information table 601 in the determination database 234. Regarding the example in FIG. 24, about Individual z, “85 points” is calculated as the sum total of item-by-item scores, and “85 points” is determined as the individual pre-correction score of Individual z.

### 4-3. Priority Potential Client List Display/Output Control

FIG. 25 depicts a flowchart inside Step 704 (priority potential client list display/output control step) in FIG. 7. Each of steps in FIG. 7 may be executed by the priority potential client list display/output control section, which is a functional section of the sales assistance system 200.

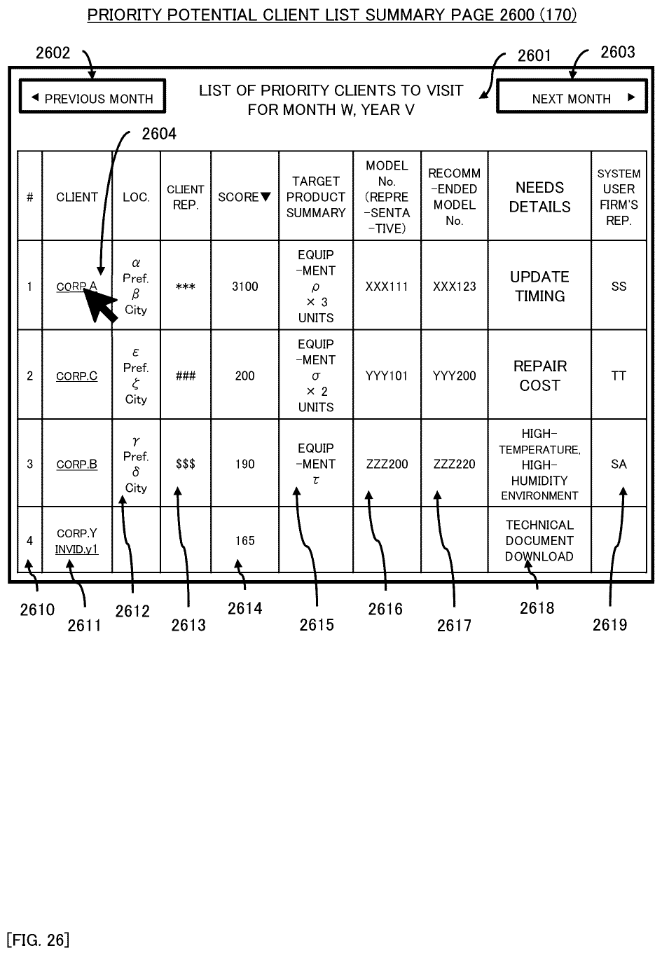

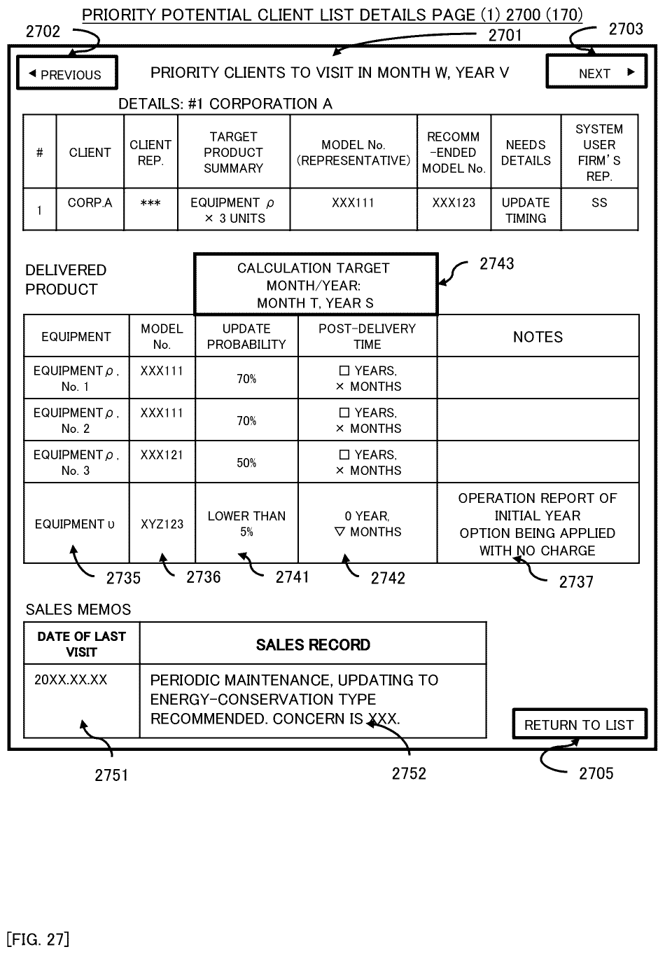

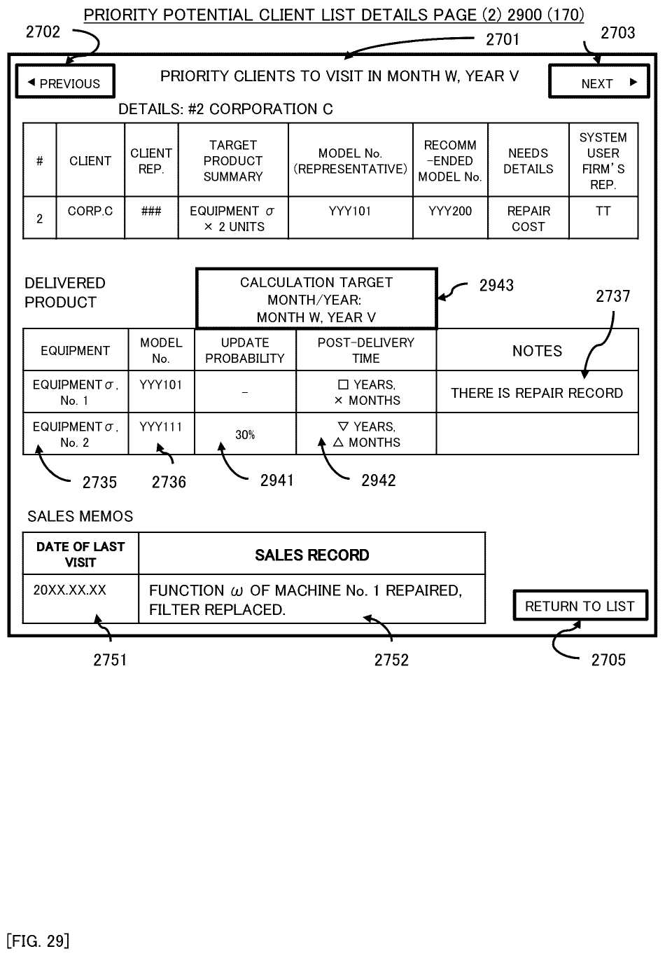

In the flowchart in FIG. 25, Steps 2502 to 2506 are for displaying or outputting a priority potential client list summary page 2600 depicted in FIG. 26. In addition, Steps 2508 to 2512 are for displaying or outputting priority potential client list details page 2700 or 2900 depicted in FIG. 27 or FIG. 29.

At Step 2501 in FIG. 25, the sales assistance system 200 (priority potential client list display/output control section) makes an assessment as to whether to or not to start displaying or outputting the priority potential client list 170. For example, in a case where there is an instruction to the sales assistance system 200 from an administrator of the sales assistance system 200 or a sales representative or the like, or in a case where a preset condition (e.g., a condition that the last day of a month has come) is satisfied, it may be determined that an assessment result of Step 2501 is YES. If an assessment result of Step 2501 is YES, the control proceeds to Steps 2502 to 2506 in order to display or output the priority potential client list summary page 2600. If an assessment result of Step 2501 is NO, (in some cases, after a certain temporal interval) Step 2501 may be repeated.

When the priority potential client list summary page 2600 is being displayed or output, at Step 2507 in FIG. 25, the sales assistance system 200 (priority potential client list display/output control section) assesses whether or not an instruction to display or output the priority potential client list details page 2700 or 2900 corresponding to a particular priority potential client has been accepted. For example, if a (hyperlinked) client name 2611 is clicked using a pointing icon 2604 on the priority potential client list summary page 2600 depicted in FIG. 26, an assessment result of Step 2507 may be determined as being YES. If an assessment result of Step 2507 is YES, the control proceeds to Steps 2508 to 2512 for displaying or outputting the priority potential client list details page 2700 or 2900 corresponding to the client name 2611 clicked using the pointing icon 2604. If an assessment result of Step 2507 is NO, the control may wait at Step 2507 until the client name 2611 is clicked using the pointing icon 2604.

When the priority potential client list details page 2700 or 2900 is being displayed or output, at Step 2513 in FIG. 25, the sales assistance system 200 (priority potential client list display/output control section) assesses whether or not an instruction to display or output the priority potential client list summary page 2600 has been accepted. For example, if a “RETURN TO LIST” icon 2705 is clicked using a pointing icon on the priority potential client list details page 2700 or 2900 depicted in FIG. 27 or FIG. 29, an assessment result of Step 2513 may be determined as being YES. If an assessment result of Step 2513 is YES, the control proceeds to Step 2506 for displaying or outputting the priority potential client list summary page 2600. If an assessment result of Step 2513 is NO, the control may wait at Step 2513 until the “RETURN TO LIST” icon 2705 is clicked using the pointing icon.

Hereinbelow, steps of processes for controlling displaying or outputting of each of the priority potential client list summary page 2600 and the priority potential client list details pages 2700 and 2900 is explained while modes of displaying or outputting of the page are depicted.

### 4-3-1. Priority Potential Client List Summary Page

FIG. 26 depicts a mode of displaying or outputting of the priority potential client list summary page 2600. On the priority potential client list summary page 2600, along with a table for list-displaying priority potential clients (or individuals belonging to new-client (candidate) corporations which are priority potential clients; hereinbelow, collectively referred to as “priority potential clients or the like”), a summary page title 2601 for representing a sales activity timing (the certain timing 160, the timing N) which is the target of the priority potential client list 170, a “PREVIOUS MONTH” icon 2602 for giving an instruction to display or output the priority potential client list summary page 2600 of the previous timing (e.g., the previous month), a “NEXT MONTH” icon 2603 for giving an instruction to display or output the priority potential client list summary page 2600 of the next timing (e.g., the next month) may be displayed or output.

The table for list-displaying the priority potential clients or the like may represent one row of record about each of the priority potential clients or the like. One row of record may include fields (columns) of a number 2610, the client name 2611, a location 2612, a client representative 2613, a post-correction score 2614, a target product summary 2615, a target product representative model number 2616, a recommended model number 2617, needs details 2618, a system user firm's representative 2619. The client names 2611 may be hyperlinked for giving instructions to display or output priority potential client list details pages.

The top row of the table for list-displaying the priority potential clients may represent the names of the fields (columns). If the name of a field (column) is clicked using a pointing icon, records included in the table for list-displaying the priority potential clients or the like may be sorted. In the example in FIG. 26, the name of a field (column) of the post-correction scores 2614 is displayed or output with “SCORE ▾.” In this case, records may be displayed or output starting from records with larger values of post-correction scores to records with smaller values of post-correction scores (in descending order). The sorting function may be enabled for some or all of the fields (columns) 2610 to 2619.

The numbers 2610 are numerals given to the priority potential clients or the like for convenience.

The client names 2611 represent the names of the priority potential clients. In a case where a priority potential client is a new client (candidate) and is a corporation, the names of individuals belonging to the corporation may be displayed or output along with the name of the corporation. FIG. 26 depicts “(individual) y1” along with “CORPORATION Y.”

The locations 2612 represent locations of the priority potential clients. For example, in a case where a product is an industrial machine, the location 2612 may represent the address of a location where the industrial machine is installed, or may represent the address of a location where a sales representative or the like visits for sales activities.

The client representatives 2613 represent representatives who consider introduction (delivery) or updating (re-delivery) of products in the priority potential clients.

The post-correction scores 2614 represent post-correction scores associated with the potential clients. The post-correction score 2614 of a new client (candidate) may be a post-correction score associated with a corporation, or may be a post-correction score of an individual belonging to the corporation. In the example in FIG. 26, “165 points,” which is a post-correction score of Individual y1 belonging to Corporation Y, is represented. In addition, in the example in FIG. 26, because the coefficient of only Corporation A is “10,” “3100 points,” which is a score obtained by multiplying the pre-correction score “310 points” of Corporation A by ten, is represented as a post-correction score of Corporation A.

The target product summaries 2615 represent summaries of products owned by the potential clients. The target product summaries 2615 may approximately represent the equipment names and numbers of units of products owned by the potential clients.

The target product representative model numbers 2616 represent the model numbers of representative products among the products owned by the potential clients.

The recommended model numbers 2617 represent the model numbers of recommended products to be newly delivered when updating (re-delivery) of the products owned by the potential clients is to be performed.

The needs details 2618 represent the names or the like of highly scored items in pre-correction scores corresponding to the potential clients. In a case where a potential client is a new client (candidate) and is a corporation, the needs details 2618 may be needs details about the corporation, or may be needs details about an individual belonging to the corporation.

The system user firm's representatives 2619 represent sales representatives or the like who perform sales activities for the potential clients.

Steps for displaying or outputting the priority potential client list summary page 2600 are explained.

At Step 2502 in FIG. 25, the sales assistance system 200 (priority potential client list display/output control section) reads out post-correction score information and needs detail information about each priority potential client or the like from the score information table 601 in the determination database 234. In a case where a priority potential client is an existing client and is a corporation owning products, the sales assistance system 200 (priority potential client list display/output control section) may read out corporation post-correction score information and corporation needs detail information. In a case where a priority potential client is a new client (candidate) and a corporation not owning products, the sales assistance system 200 (priority potential client list display/output control section) may read out individual post-correction score information and individual needs detail information about an individual belonging to the corporation, or may read out corporation post-correction score information and corporation needs detail information about the corporation. In a case where a priority potential client is an individual not belonging to a corporation, the sales assistance system 200 (priority potential client list display/output control section) may read out individual post-correction score information and individual needs detail information about the individual.

At Step 2503 in FIG. 25, the sales assistance system 200 (priority potential client list display/output control section) reads out the location information 322, the client representative information 323, the target product summary information 325, the target product representative model number information 326, and the system user firm's representative information 329 about each priority potential client or the like from the client information data 301 in the sales record database 231.

At Step 2504 in FIG. 25, the sales assistance system 200 (priority potential client list display/output control section) reads out information about a recommended model number (new model number) associated with the model number (old model number) of a representative product among products owned by each priority potential client from the old-model-number/new-model-number association information 416 included in the product specification data 401 in the product information database 232.

At Step 2505 in FIG. 25, the sales assistance system 200 (priority potential client list display/output control section) sorts the priority potential clients or the like such that the priority potential clients or the like are listed starting from those with larger post-correction scores (in descending order), on the basis of the post-correction score information about the priority potential clients or the like, and determines the initial arrangement of records of priority potential clients available when the priority potential client list summary page 2600 is displayed or output.

At Step 2506 in FIG. 25, the sales assistance system 200 (priority potential client list display/output control section) performs control to display or output the priority potential client list summary page 2600 with the records about the priority potential clients or the like (records listing the information read out at Steps 2502, 2503, and 2504) being arranged next to each other in the order as sorted at Step 2505.

### 4-3-2. First Example of Priority Potential Client List Details Page

FIG. 27 depicts a mode of displaying or outputting of a first example of the priority potential client list details page. In this first example, detail information about Corporation A having products which are post-delivery-time-attributed update proposal targets is represented.

Along with records similar to the records about Corporation A on the priority potential client list summary page 2600, the priority potential client list details page 2700 includes a table including a record about each product owned by Corporation A, and a sales memo.

The priority potential client list details page 2700 may further display or output a details page title 2701 for representing a sales activity timing (the certain timing 160, the timing N) which is the target of the priority potential client list 170, a “PREVIOUS” icon 2702 for giving an instruction to display or output a priority potential client list details page about a priority potential client or the like which is the previous record on the table for list-displaying the priority potential clients or the like in the priority potential client list summary page 2600, a “NEXT” icon 2703 for giving an instruction to display or output a priority potential client list details page about a priority potential client which is the next record in the table for list-displaying the priority potential clients or the like, and a “RETURN TO LIST” icon 2705 for giving an instruction to display or output the priority potential client list summary page 2600.

The table including a record of each product owned by a priority potential client (Corporation A in the example in FIG. 27) may represent one row of record about each product owned by the priority potential client (Corporation A). The one row of record may have fields of an equipment name 2735, a model number 2736, an update probability 2741, post-delivery time 2742, and notes 2737. In addition, the table including the record of each product owned by the priority potential client (Corporation A in the example in FIG. 27) may include a calculation target month/year 2743 representing a target timing of calculation of the update probabilities 2741 and the post-delivery time 2742.

The sales memo may include fields of a date of last visit 2751 and a sales record 2752.

The equipment names 2735 represent the names of products owned by the potential client. In a case where the potential client owns a plurality of products (equipment) of similar types, the equipment names 2735 may be given numerals for making distinctions among the products (equipment).

The model numbers 2736 represent the model numbers of the products owned by the potential client.

The post-delivery time 2742 represents time that has elapsed from delivery of the products owned by the priority potential client by the timing represented by the calculation target month/year 2743. That is, the post-delivery time 2742 represents elapsed time from the timings when the products owned by the priority potential client are introduced (delivered) or updated (re-delivered) by the timing represented by the calculation target month/year 2743. Since FIG. 27 depicts detail information about Corporation A having products to be post-delivery-time-attributed update proposal targets, the calculation target month/year 2743 can be ahead of the sales activity timing (the certain timing 160, the timing N) represented by the details page title 2701. In that case, the post-delivery time 2742 also represents post-delivery time ahead of the timing.

The notes 2737 are reference information about products owned by the priority potential client. In fields of the notes 2737, information may be written automatically on the basis of predetermined rules, or sales representatives or the like may write information that has been obtained through sales activities.

The date of last visit 2751 represents the date when a sales representative or the like made a visit to the priority potential client. Note that not only the date of last visit but also the history of dates of visit may be displayed or output, in another possible mode.

The sales record 2752 represents information obtained when the sales representative or the like made the visit to the priority potential client.

The update probabilities 2741 represent estimated probabilities that the products owned by the priority potential client are updated (re-delivered) by the elapsed time represented by the post-delivery time 2742.

FIG. 28 depicts the relation between the post-delivery time 2742 and the update probabilities 2741. The product specification data 401 in the product information database 232 includes the update timing distribution information 413 about each model number (or about each group of model numbers). About each of products (products having operated in the past) belonging to a model number (or a group of model numbers), the update timing distribution information 413 includes statistical information (history information) about time (update time) between introduction (delivery) of the product and updating (re-delivery) of the product. FIG. 28 depicts a bar chart 2800 in which the horizontal axis represents update time of each product and the vertical axis represents the number (number of units) of updated products and which is based on the update timing distribution information 413. If a predetermined value is determined as the post-delivery time 2742 on this bar chart 2800, a value obtained by dividing the number of products updated before the time corresponding to the predetermined value on the bar chart 2800 (the sizes of black bars in FIG. 28) by the total number of products displayed on the bar chart 2800 (the total of the sizes of the black bars and the sizes of white bars in FIG. 28) is determined as the statistical update probability 2741.

In FIG. 27, once the post-delivery time 2742 of a product owned by the priority potential client is set, the update probability 2741 of the product can be set on the basis of the update timing distribution information 413 about the model number of the product (a group of model numbers).

By displaying or outputting the update probabilities 2741 on the priority potential client list details page 2700, it becomes easier for a sales representative or the like to, when performing sales activities for the priority potential client or the like, talk the priority potential client into updating (ordering re-delivery of) a product, by using statistical data, while allowing the priority potential client or the like to recognize the degree of necessity for updating (re-delivery) of the product.

Steps for displaying or outputting the priority potential client list details page 2700 are explained.

At Step 2508 in FIG. 25, the sales assistance system 200 (priority potential client list display/output control section) reads out the equipment name information 335, the model number information 336, the delivery timing information 342, and the note information 337 about each of products owned by a particular priority potential client which is the target of the priority potential client list details page 2700, from the client information data 301 in the sales record database 231.

At Step 2509 in FIG. 25, the sales assistance system 200 (priority potential client list display/output control section) reads out the date-of-last-visit information 351 and the sales record information 352 about the particular priority potential client which is the target of the priority potential client list details page 2700, from the client information data 301 in the sales record database 231.

At Step 2510 in FIG. 25, about each of the products owned by the particular priority potential client which is the target of the priority potential client list details page 2700, the sales assistance system 200 (priority potential client list display/output control section) reads out the update timing distribution information 413 about a model number of the product (or a group of model numbers) from the product specification data 401 in the product information database 232.

At Step 2511 in FIG. 25, about each of the products owned by the particular priority potential client which is the target of the priority potential client list details page 2700, the sales assistance system 200 (priority potential client list display/output control section) calculates the post-delivery time 2742. About each of the products owned by the particular priority potential client which is the target of the priority potential client list details page 2700, the sales assistance system 200 (priority potential client list display/output control section) calculates the update probability 2741 on the basis of the post-delivery time 2742 and the update timing distribution information 413.

At Step 2512 in FIG. 25, the sales assistance system 200 (priority potential client list display/output control section) performs control to display or output the priority potential client list details page 2700 including the information obtained at Steps 2502 to 2504 and the information obtained at Steps 2508 to 2511 about the particular priority potential client which is the target of the priority potential client list details page 2700.

### 4-3-3. Second Example of Priority Potential Client List Details Page

FIG. 29 depicts a mode of displaying or outputting of a second example of the priority potential client list details page. In this second example, detail information about Corporation C having products which are repair-cost-attributed update proposal targets is represented. Hereinbelow, only differences from the first example in FIG. 27 are explained.

In the example depicted in FIG. 29, Corporation C which is the target of a priority potential client list details page 2900 owns a product “EQUIPMENT σ, No. 1” which is a repair-cost-attributed updating target. Since the “EQUIPMENT σ, No. 1” may be updated (re-delivered) already at the timing when sales activities are performed, the timing represented by the details page title 2701 and the timing represented by a calculation target month/year 2943 may be the same in FIG. 29. Along with this, in FIG. 29, an update probability 2941 and post-delivery time 2942 may have values obtained at the timing when sales activities are performed.

Since “EQUIPMENT σ, No. 1” is already a repair-cost-attributed update proposal target, it is not so necessary to consider the update probability 2941 associated with the post-delivery time 2942 about “EQUIPMENT σ, No. 1.” Accordingly, the update probability 2941 is not written about “EQUIPMENT σ, No. 1” in FIG. 29.

### 5. Others (Modification Examples)

The present disclosure is not limited to the embodiment described above, and includes various modification examples. Some of constituent elements or processes according to the embodiment may be replaced with constituent elements or processes according to another conceivable embodiment. Constituent elements or processes according to another conceivable embodiment may be added to constituent elements or processes according to the embodiment.

For example, in the present disclosure, there can be modification examples of the embodiment like the ones below.

### (α) Execution of Sales Assistance Method (Sales Assistance Program) by Sales Representative Terminal

In the embodiment described above, the information processing system 180 (computer) executes the sales assistance method 100 (sales assistance program). The sales representative terminal 181 may perform control to display or output the priority potential client list 170 by transmitting information obtained through sales activities to the information processing system 180 (computer) or using information about the priority potential client list 170 transmitted from the information processing system 180 (computer).

In contrast, in a modification example, the sales representative terminal 181 itself may execute the sales assistance method 100 (sales assistance program). Various types of databases may be retained by the sales representative terminal 181 itself, or the sales representative terminal 181 may be able to access various types of databases.

In this manner, the system configuration for the present disclosure can be determined flexibly. As long as the hardware performance of the sales representative terminal 181 is sufficient, simplification of the system configuration is possible.

### (β) Reading Out Databases in Advance and Caching Data

The embodiment described above has a mode in which various types of databases are accessed on an as-needed basis.

In contrast, in a modification example, prior to execution of the sales assistance method 100 of the present disclosure, necessary data is read out in advance from various types of databases and cached, and thereafter, the cached data is accessed solely, in another possible mode.

According to such a modification example, the access speed after the caching of data of the databases is enhanced, and the processing speed of the sales assistance system 200 after the caching is enhanced.

### (γ) Elapsed Time and Operation Duration

In the embodiment described above, about products owned by potential clients, elapsed time (post-delivery time) from introduction (delivery) or updating (re-delivery) is handled.

In contrast, in a modification example, about products owned by potential clients, operation duration after delivery or re-delivery may be handled. In order to handle operation duration, information about products owned by potential clients being operationally used (being in operation) may be transmitted from the systems of the existing clients depicted in FIG. 1 and received by the information processing system 180 (sales assistance system 200). For example, information about operation duration of products owned by potential clients or about time periods during which the products are in operation may be transmitted and received.

If timings of updating (re-delivery) of products owned by potential clients are estimated on the basis of operation duration from delivery or re-delivery of the products, enhancement of the precision of the estimated update timing (information) 343 can be expected.

### (δ) Stepwise Priority Measures

In the embodiment described above, in a case where a priority measure is to be taken, the sales assistance system 200 sets the value of a coefficient to “10” (a value obtained by multiplying a pre-correction score by ten is determined as a post-correction score).

In contrast, in a modification example, the value of a coefficient (or a to-be-added value) may be set depending on the content of a reason for applying a priority measure. For example, there may be a case where “5” other than “1” and “10” is applied as the value of a coefficient. The same also applies to a case where to-be-added values are used.

In such a modification example, it becomes possible to make finer determinations about priority potential clients of the timing N.

### (ε) Careful Consideration to New Versions of Software Used for Products

In the embodiment (or modification examples) of the present disclosure, (although an explanation thereof is omitted in the description above) careful consideration may be given to calculation of item-by-item scores or pre-correction scores in a case where hardware and software collaborate in products owned by potential clients.

For example, if a new version of software used for a product (e.g., software of an operating system) is launched, there is a high possibility that this gives potential clients an impression that the overall performance of the product has relatively deteriorated. That is, it can be effective to appeal to the potential clients to update (order re-delivery of) the product upon the launch of a new version of software.

In view of this, as represented by score addition “+50 POINTS PER PRODUCT” for the item “LAUNCH OF NEW VERSION OF SOFTWARE USED FOR PRODUCT” in FIG. 23, the sales assistance system 200 (pre-correction score calculating section) may adjust item-by-item scores such that, in a case where a new version of software used for a product owned by potential clients (e.g., software of an operating system) is launched, pre-correction scores of the potential clients are increased.

The technical matters depicted for the embodiment of the present disclosure and the modification examples of the embodiment depicted in the description above can be combined as appropriate unless such combinations cause technical contradictions.

What is claimed is:

1. A sales assistance method executed by a computer, the sales assistance method comprising:
a priority potential client determination step of determining, from among potential clients, a priority potential client to be treated as a priority target of a sales activity to be performed at a certain timing; and
a priority potential client list display/output control step of performing control to display or output a priority potential client list representing information about the priority potential client of the certain timing, wherein
the priority potential client determination step includes, as steps to be executed for each of the potential clients,
an estimated update timing determination step of determining an estimated update timing which is an estimated timing when a product owned by a potential client is to be updated,
an estimated proposal period determination step of determining whether or not the certain timing is included in an estimated proposal period which is a period suitable to propose updating of the product to the potential client in order to update the product at the estimated update timing, and
a priority measure step of treating the potential client such that the potential client is likely to be determined as the priority potential client for the certain timing, in a case where the certain timing is included in the estimated proposal period of the potential client.

2. The sales assistance method according to claim 1, wherein
the estimated update timing determination step includes
an estimated update time determination step of determining estimated update time estimated as time between delivery, to the potential client, of the product owned by the potential client and updating of the product, on a basis of recommended update time set for the product and information representing an environmental status of a location where the product is installed, and
an estimated update timing calculation step of calculating the estimated update timing on a basis of information about a timing when the product has been delivered to the potential client and the estimated update time.

3. The sales assistance method according to claim 2, wherein
the recommended update time of the product is set twice as large as rated time of the product.

4. The sales assistance method according to claim 2, wherein
the information representing the environmental status of the location where the product is installed includes information representing a temperature of the location where the product is installed, and
the estimated update time determination step includes computation in which the information representing the temperature is applied to an Arrhenius equation.

5. The sales assistance method according to claim 1, wherein
the priority potential client determination step includes, as steps to be executed for each of the potential clients,
an estimated proposal deadline determination step of determining an estimated proposal deadline which is an estimated deadline for proposing updating of the product to the potential client, on a basis of the estimated update timing of the product and typical installation time which is typical time required for installation work to be performed when the product is updated,
a post-delivery-time-attributed update proposal target determination step of determining that the product owned by the potential client is a post-delivery-time-based update proposal target, in a case where the estimated proposal deadline of the product comes within predetermined time from the certain timing, and
an estimated consideration period determination step of determining whether or not the certain timing is included in an estimated consideration period which is an estimated period during which the potential client is likely to consider updating of the product, and
the estimated proposal period determination step includes a post-delivery-time-attributed estimated proposal period determination step of assessing that the certain timing is included in the estimated proposal period, in a case where the product owned by the potential client is a post-delivery-time-based update proposal target and the certain timing is included in the estimated consideration period.

6. The sales assistance method according to claim 5, wherein
the estimated consideration period is estimated on a basis of information representing a financial result timing of the potential client or information representing an estimated budget formulation timing.

7. The sales assistance method according to claim 6, wherein
the certain timing corresponding to the priority potential client list can be set at an interval shorter than time that elapses from the estimated consideration period to the estimated budget formulation timing.

8. The sales assistance method according to claim 1, wherein
the priority potential client determination step includes, as steps to be executed for each of the potential clients,
a repair-cost-attributed update proposal target determination step of determining that the product owned by the potential client is a repair-cost-based update proposal target, in a case where information representing a maintenance status of the product represents a predetermined status,
an estimated consideration period determination step of determining whether or not the certain timing is included in an estimated consideration period which is an estimated period during which the potential client is likely to consider updating of the product,
a repair-cost-attributed estimated proposal period determination step of assessing that the certain timing is included in a repair-cost-attributed estimated proposal period, in a case where the product owned by the potential client is a repair-cost-based update proposal target and the certain timing is included in the estimated consideration period, and
a repair-cost-attributed priority measure step of treating the potential client such that the potential client is likely to be determined as the priority potential client for the certain timing, in a case where the certain timing is included in the repair-cost-attributed estimated proposal period of the potential client.

9. The sales assistance method according to claim 8, wherein
the repair-cost-attributed update proposal target determination step includes determining that the information representing the maintenance status of the product represents the predetermined status, in a case where the information representing the maintenance status of the product represents that a repair cost of the product in a predetermined period is equal to or greater than an expense for periodic maintenance of the product in the predetermined period or represents that the number of times of failures of the product in the predetermined period is equal to or greater than a predetermined number of times.

10. The sales assistance method according to claim 1, wherein
the priority measure step makes a coefficient for correcting a pre-correction score associated with a certain potential client a relatively large value in a case where the certain potential client is treated such that the certain potential client is likely to be determined as the priority potential client, and
the priority potential client determination step includes a priority potential client specifying step of specifying the priority potential client by using a score that is associated with each of the potential clients and has been corrected with the coefficient.

11. The sales assistance method according to claim 1, wherein
the priority potential client determination step includes, as steps to be executed for each of the potential clients,
an estimated proposal deadline determination step of determining an estimated proposal deadline which is an estimated deadline for proposing updating of the product to the potential client, on a basis of the estimated update timing of the product and typical installation time which is typical time required for installation work to be performed when the product is updated,
a post-delivery-time-attributed update proposal target determination step of determining that the product owned by the potential client is a post-delivery-time-based update proposal target, in a case where the estimated proposal deadline of the product comes within predetermined time from the certain timing,
a repair-cost-attributed update proposal target determination step of determining that the product owned by the potential client is a repair-cost-based update proposal target, in a case where information representing a maintenance status of the product represents a predetermined status,
a pre-correction score calculation step of calculating a pre-correction score associated with the potential client, by adding a score for each preset item, in which a score with a relatively large value is given to the potential client in a case where the product owned by the potential client is determined as a post-delivery-time-based update proposal target or is determined as a repair-cost-based update proposal target, and
a repair-cost-attributed priority measure step of making a coefficient for correcting a pre-correction score associated with a certain potential client a relatively large value in a case where the certain potential client is treated such that the certain potential client is likely to be determined as the priority potential client for a reason attributable to a repair cost,
the priority measure step makes a coefficient for correcting a pre-correction score associated with a certain potential client a relatively large value in a case where the certain potential client is treated such that the certain potential client is likely to be determined as the priority potential client for a reason attributable to post-delivery time, and
the priority potential client determination step includes a priority potential client specifying step of specifying the priority potential client by using a score that is associated with each of the potential clients and has been corrected with the coefficient.

12. The sales assistance method according to claim 1, wherein
the priority potential client list display/output control step performs control such that, when information about a certain priority potential client included in the priority potential client list of the certain timing is to be displayed or output, information about an estimated update probability or post-delivery time of each product owned by the certain priority potential client and about a timing associated with the update probability or the post-delivery time is represented,
the update probability represents an estimate of a probability that the product is to be updated before a timing associated with the update probability, and
the post-delivery time represents time that has elapsed from a timing when the product has been delivered to a timing associated with the post-delivery time.

13. A sales assistance program that causes a computer to execute a sales assistance method, wherein
the sales assistance method includes
a priority potential client determination step of determining, from among potential clients, a priority potential client to be treated as a priority target of a sales activity to be performed at a certain timing, and
a priority potential client list display/output control step of performing control to display or output a priority potential client list representing information about the priority potential client of the certain timing, and
the priority potential client determination step includes, as steps to be executed for each of the potential clients,
an estimated update timing determination step of determining an estimated update timing which is an estimated timing when a product owned by a potential client is to be updated,
an estimated proposal period determination step of determining whether or not the certain timing is included in an estimated proposal period which is a period suitable to propose updating of the product to the potential client in order to update the product at the estimated update timing, and
a priority measure step of treating the potential client such that the potential client is likely to be determined as the priority potential client for the certain timing, in a case where the certain timing is included in the estimated proposal period of the potential client.

14. A sales assistance system comprising:
a priority potential client determining section that determines, from among potential clients, a priority potential client to be treated as a priority target of a sales activity to be performed at a certain timing; and
a priority potential client list display/output control section that performs control to display or output a priority potential client list representing information about the priority potential client of the certain timing, wherein
the priority potential client determining section includes, as sections that operates for each of the potential clients,
an estimated update timing determining section that determines an estimated update timing which is an estimated timing when a product owned by a potential client is to be updated,
an estimated proposal period determining section that determines whether or not the certain timing is included in an estimated proposal period which is a period suitable to propose updating of the product to the potential client in order to update the product at the estimated update timing, and
a priority measure section that treats the potential client such that the potential client is likely to be determined as the priority potential client for the certain timing, in a case where the certain timing is included in the estimated proposal period of the potential client.

15. The sales assistance system according to claim 14, wherein
the sales assistance system can access a sales record database, a product information database, a corporation database, and a determination database,
the sales record database has client information data including client information about each of the potential clients,
the product information database has product specification data including information about a specification of each product model number and client-owned-product data including information about a product owned by each of the potential clients,
the corporation database has corporation data including corporation information about each of the potential clients, and
the determination database has score information about each of the potential clients.
